(19) United States
(12) Patent Application Publication
(10) Pub. No.: US 2012/0284124 A1
(43) Pub. Date: Nov. 8, 2012

(54) BUILDING ENERGY PERFORMANCE/IMPROVEMENTS

(76) Inventors: Matej HARANGOZO, Columbia, MD (US); Josh NOTES, Columbia, MD (US)

(21) Appl. No.: 13/465,744

(22) Filed: May 7, 2012

Related U.S. Application Data
(60) Provisional application No. 61/483,144, filed on May 6, 2011.

(51) Int. Cl. G06Q 50/16; G06Q 30/02

(52) U.S. Cl. 705/14.66; 705/314

(57) ABSTRACT

A building energy improvement system and method for electronically collecting building energy profile data and auditing the building energy profile data to identify at least one building improvement to enhance building energy performance.

### CROSS-REFERENCE TO RELATED APPLICATIONS

This application claims the benefit under 35 U.S.C. §119(e) of U.S. Provisional Application No. 61/483,144, filed on May 6, 2011, the content of which is hereby incorporated by reference in its entirety.

### FIELD

A building energy improvement system and method for electronically collecting building energy profile data and auditing the building energy profile data to identify at least one building improvement to enhance building energy performance. In addition, a building energy improvement program administration management system and method for tracking financial, real time data reporting, operational, quality assurance/control, contractor management, and rebate components of such program structures.

### BACKGROUND

There has exists an interest in increasing building energy performance by reducing energy inefficiencies by both consumers and businesses to save energy and reduce operational costs. There are many different types of building energy inefficiencies, which some or all can be reduced by evaluating the performance of various aspects and components of energy consumption and waste in a building to identify building improvements that will be cost effective to implement. For example, various building improvements can include replacing damaged and/or inefficient building equipment such as appliances and business equipment, inefficient building heating systems, increasing building insulation values for roofs and walls by adding and/or replacing insulation, replacing standard thermostats with new programmable thermostats, replacing old, damaged, and/or inefficient windows and doors with new insulated replacement windows and doors, and a variety of other improvements that can enhance building energy performance by reducing building energy consumption.

In order to evaluate building energy consumption, the energy consumption rate of appliances and equipment along with the rate of loss of heat energy from the building must be measured at the location of the building to then conduct a building energy audit.

As shown in FIG. 1, in the past a contractor manually conducted an building energy audit, by using diagnostics, generating a report, and recommending building improvements to the building owner and/or manager, and then conducting retrofit work to install the building improvements.

There exists a need for an efficient system and method for the collection of building energy data, communicating and storing the building energy data, auditing the building energy data to identify one or more building improvements to enhance building energy performance, determine the cost of the building improvements, contracting and scheduling one or more vendors to install the building improvements, and test and evaluate the building improvements to ensure the building improvements are performing. Additionally, there exists a need to report, manage, and quality assure these projects on a mass scale and as a result program administrators are deployed to run such programs where government, state, local, private and public funding combined with energy improvement contractor participation can be translated into regional incentive/rebate based energy reduction. FIG. 1 shows an example model of such an efficient system and method.

### SUMMARY

A first object is to provide an improved system and method of increasing building energy performance.

A second object is to provide an improved system and method of increasing building energy performance by identifying and installing one or more building improvements for decreasing building energy waste or inefficiencies.

A third object is to provide an improved system and method of auditing building energy waste or inefficiencies on a mass program level scale.

A fourth object is to provide an improved system and method of making building energy performance improvements.

A fifth object is to provide an improved system and method of communicating building energy profile data for the purpose of increasing building energy performance and reducing resources on a program level.

A sixth object is to provide an improved system and method of auditing building energy profile data for the purpose of increasing building energy performance.

A seventh object is to provide an improved system and method of identifying one or more building energy performance improvements.

An eight object is to provide an improved system and method for targeting building energy performance improvements prioritized based on effectiveness.

A ninth object is to provide an improved system and method for implementing one or more building energy performance improvements.

A tenth object is to provide an improved system and method for testing the performance of one or more installed building energy performance improvements.

An eleventh object is to provide an improved system and method of identifying one or more building energy performance improvements, prioritizing the one or more building energy performance improvements based on cost of the improvement, percent increase in energy performance of building due to a particular improvement, and/or value of the improvement based on cost and benefit.

A twelfth object is to provide an improved system and method of measuring and determining the rates or levels of use and consumption of energy in a building.

A thirteenth object is to provide a system and method comprising or consisting of an interactive digital library of problems and solutions with customized training and support.

A fourteenth object is to provide a system and method comprising or consisting of an estimate creation wizard with report output integration and accounting integration.

A fifteenth object is to provide a system and method comprising a modular administration program building.

A sixteenth object is to provide a system and method comprising or consisting of an energy audit lead valuation system.

A seventeenth object is to provide a system and method comprising or consisting of a real time quality assurance dispatching.

An eighteenth object is to provide a system and method comprising or consisting of a rugged mobile device, or computer with IR digital camera having flash, video conference capability, and laser measurement tool for 3D building (house) modeling applications.

A nineteenth object is to provide a dynamic data matrix with front end GUI to an MySQL database developed inside a linux environment.

A twentieth object is to provide a system and method comprising or consisting of a networked server receiving via a communication interface building energy profile data from the electronic communication device, the networked server comprising an interactive library of problems and solutions with training.

A twenty first object is to provide a system and method comprising or consisting of a networked server receiving via a communication interface the building energy profile data from the electronic communication device, the networked server comprising: an estimate creation wizard with report output integration, accounting integration, and supplier/vendor market place integration.

A twenty second object is to provide a system and method comprising or consisting of a modular administration program build out.

A twenty third object is to provide a system and method comprising or consisting of collecting building energy profile data using an electronic communication device, a networked server receiving via a communication interface the building energy profile data from the electronic communication device, the networked server comprising an interactive library of problems and solutions with training, an estimate creation wizard with report output integration and accounting integration; and a modular administration program build out; and auditing the building energy profile data to identify at least one building improvement to improve the energy performance of the building.

A twenty fourth object is to provide a system and method comprising an interactive library of problems and solutions with training, an estimate creation wizard with report output integration, accounting integration, and supplier/vendor market place integration, wherein the training is customized industry training through the problems and solutions library with custom company protocols with pictures, audio, video or text.

A twenty fifth object is to provide a system and method comprising or consisting of an estimate creation wizard with report output integration, accounting integration, and supplier/vendor market place integration wherein the estimation creation wizard is connected to suppliers based deals advertising based on data collection.

A twenty sixth object is to provide a system and method comprising or consisting of a modular administration program build out, wherein the modular administration program build out is a program/subprogram/stage structure build out.

A twenty seventh object is to provide a system and method comprising at least one selected from the group consisting of a specific data collection interface build out, an management wizard, specific report output creation wizard, modular financial/payment structure wizard, permission/filter based user account creation wizard, and automatic tiered report outputs based on permissions.

A twenty eighth object is to provide a system and method comprising a building energy audit lead valuation system.

A twenty ninth object is to provide a system and method comprising a building energy audit lead valuation system, wherein the energy audit lead valuation system comprises at least one selected from the group consisting of taking third party data sets that have, close relation to the energy efficiency/retrofit or real estate data requirements and evaluating its value for potential expansion on this data and assigning lead valuation through the creation of partial or full building improvement data sets for industry specific data collectors based on industry improvement standards.

A thirtieth object is to provide a system and method for improving building energy performance comprising or consisting of real time quality assurance dispatching.

A thirty first object is to provide a system and method for improving building energy performance comprising or consisting of an electronic communication device is a net book or a mobile device with an extended external case comprising an infrared camera.

A thirty second object is to provide a system and method for improving building energy performance comprising or consisting of a net book or a mobile device with an extended external case comprising a high zoom digital camera with a flash.

A thirty third object is to provide a system and method for improving building energy performance comprising or consisting of a net book or a mobile device with an extended external case comprising at least one selected from the group consisting of video conference capability and laser measurement tool for a three dimensional (3D) building modeling application.

A thirty fourth object is to provide a system and method for improving building energy performance comprising or consisting of a dynamic data matrix with a front end GUI to an MySQL database developed inside a linux environment.

A thirty fifth object is to provide a system and method for improving building energy performance comprising or consisting of installing the improvement to the building.

A thirty sixth object is to provide a system and method for improving building energy performance comprising or consisting of testing out the performance of the improvement and communicating real time quality assurance and control data.

A thirty seventh object is to provide a system and method for improving building energy performance comprising or consisting of generating a building improvement plan using the evaluated building energy profile data.

A thirty eighth object is to provide a system and method for improving building energy performance comprising or consisting of generating a price quotation for the at least one improvement.

A thirty ninth object is to provide a system and method for improving building energy performance comprising or consisting of scheduling a contractor to install the at least one improvement to the building.

A fortieth object is to provide a system and method for improving building energy performance comprising or consisting of at least one improvement made on the building by a home improvement contractor.

A forty first object is to provide a system and method for improving building energy performance comprising or consisting of generating a building energy performance improvement plan using the audit.

A forty second object is to provide a system and method for improving building energy performance comprising or consisting of generating an audit upon receipt of a customer order.

A forty third object is to provide a system and method for improving building energy performance comprising or consisting of generating an audit automatically upon acquisition of the building energy profile data.

A forty fourth object is to provide a system and method for improving building energy performance comprising or consisting of at least partially generating an audit by an electronic communication device.

A forty fifth object is to provide a system and method for improving building energy performance comprising or consisting of generating an audit by a networked server.

A forty sixth object is to provide a system and method for improving building energy performance comprising or consisting of at least partially generating a building energy performance improvement plan using an electronic communication device.

A forty seventh object is to provide a system and method for improving building energy performance comprising or consisting of generating a building energy performance improvement plan using a server.

A forty eighth object is to provide a system and method for improving building energy performance comprising or consisting of scheduling at least one building improvement from a network of approved building improvement contractors for a particular geographic area.

A forty ninth object is to provide a system and method for improving building energy performance comprising or consisting of selecting an approved building improvement contractor by using a server.

A fiftieth object is to provide a system and method for improving building energy performance comprising or consisting of generating a building energy profile data comprising at least one selected from the group consisting of at least one physical measurement of the building, at least one measurement of heat transfer rate of energy moving into or out of the building, at least one digital photograph of the building, at least one record of any damage to the home, and a listing of at least one repair or improvement to the building.

A fifty first object is to provide a system and method for improving building energy performance comprising or consisting using an electronic communication device selected from the group consisting of a cell phone, personal computer, laptop computer, personal communication device, and portable computer devices.

A fifty second object is to provide a system and method for improving building energy performance comprising or consisting of generating a building energy profile data comprises at least one selected from the group consisting of house type, number of occupants, year house was built, approx. size of house, primary heating system fuel type, number of heating systems, air conditioning (yes/no), primary domestic hot water fuel type, number of water heaters, electric Service Provider; and fuel Service Provider.

A fifty third object is to provide an improved system and method for reducing the time conducting a building performance job.

The system and method can include one or more features, including a business processing application (e.g. Content Management System (CMS), Customer Relationship Manager (CRM)), scheduling system(s), HR management, data collection, data reporting, output automation, and communication applications into one platform and allows for custom modular creation of specific user accounts that cater to particular needs of industry specific users. It also can combine an electronic communication device (e.g. mobile hardware) for external off line data collection that then sync with the online platform for processing or further processing the

The system is configured to allow the modular build out of specific functions, filters, and processing that are particular to the different levels of the energy efficiency industry, which are pre-built into the plat form and requires little to none modification and coding. It also provides an open API (application programming interface) to connect to any data provider or administrator in the industry. A trained user can design a whole energy efficiency administrative programs with all necessary functions and processing from the highest level of oversight to the specific needs of all third party contractors involved in the process.

The system creates real time data reporting and tracking of all moving parts in an energy efficiency program that include such reports as energy savings on regional or individual real estate property level, performance data on the program and all personnel involved, real time safety response and automation of quality assurance protocols, real time inventory and financial components of the program and many others. Many of the other advantages are reduction of materials, human resources, and costs of energy efficiency/retrofit programs and increases the quality assurance and quality control of these programs

The uses of the system include full business operational SaaS (Software as a Service) platform for Energy Efficiency and retrofit contractors, full energy retrofit and efficiency administrative program operation SaaS (Software as a Service) platform, full quality assurance with real time data processing SaaS (Software as a Service) platform, and data collection and reporting platforms for real estate industry users.

The system includes the following features and functionality, including 1) industry training through problem and solution library with custom company protocols with pic, audio, video or text, 2) modularity of program/sub program by stage and jobs, 3) payment modularity per button and filters and etc.

In addition, the system can include an online brokerage and real time inventory system between all parties of the Energy Efficiency/Retrofit industry, Home Owner project manager platform with work order and contractor performance tracking, Estimation creation wizard connection to suppliers based deals advertising based on data collection, Live video Quality Assurance in the field, and Assigning lead valuation through the creation of partial or full home improvement data sets for industry specific data collectors based on industry improvement standards.

Further, the system can include the ability to generate energy modeling on residential structures having a standardized third party API friendly development environment that would allow any third party developer to extend the system as needed. The system can also include a breakaway offline component/application available on the Windows operating system, Android, and IOS 5 for the iPad.

A data communication standard needs to be finalized in the energy efficiency/retrofit industry itself, which would allow seamless integration with all other software tools and industry requirements across the board. For example, the HPXML may be suitable for this purpose.

The system and method reduces the amount of time to conduct a building performance job. For example, an average savings of 12.85 hours per building performance job can be achieved. The system and method also integrate a building energy.

### BRIEF DESCRIPTION OF DRAWINGS

FIG. 1 is a diagrammatic view of a past work model and a present work model for the system and method.

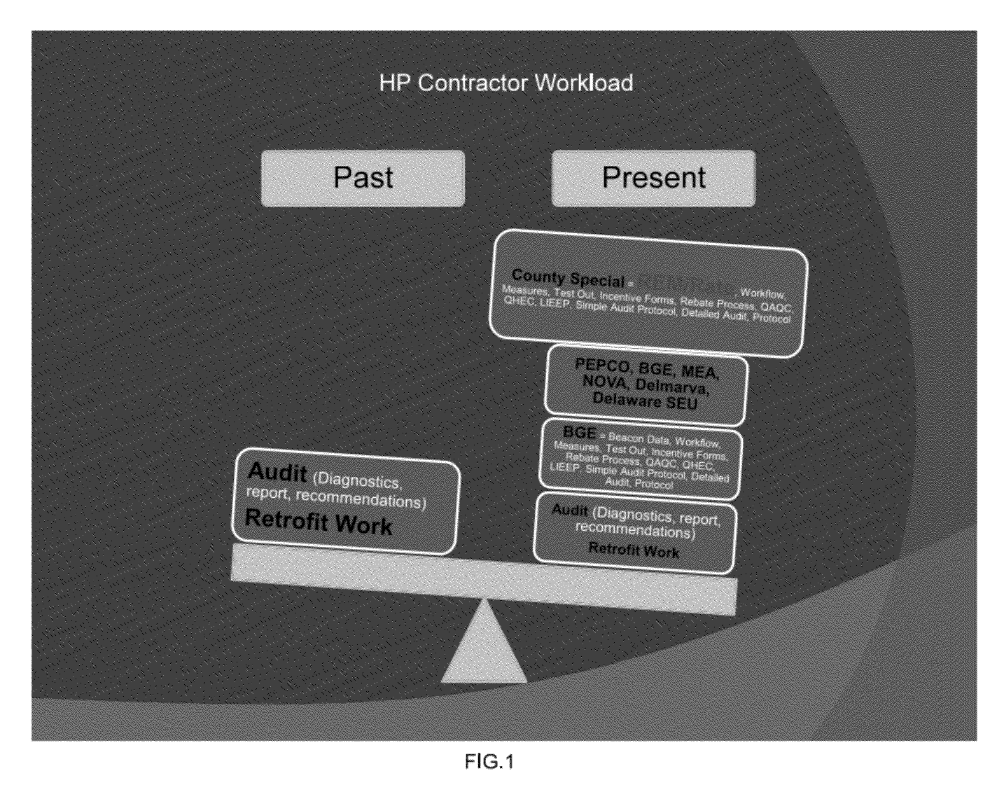

FIG. 2 is a diagrammatic view of a flow chart of steps for the system and method.

FIG. 3 is a screen shot of the central business management platform and data collection interface application for collecting customer information.

FIG. 4 is another screen shot of the central business management platform and data collection interface application for collecting customer information offline/online in the field by an energy auditor, building (home) improvement contractor, home inspector, or a quality insurance inspector.

FIG. 5 is a diagrammatic view of integration of energy audit and building (home) improvement business models.

FIG. 6 is a diagrammatic view of integration of diverse business models for customer satisfaction.

FIG. 7 is a diagrammatic view of supported business models for building (home) performance industry.

FIG. 8 is a diagrammatic view of the integration and sharing of data with outside vendors.

FIG. 9 is a screen shot of efficiency, automation, and continuous training.

FIG. 10 is a diagrammatic view of the interactive digital library of problems and solutions with customized training and support.

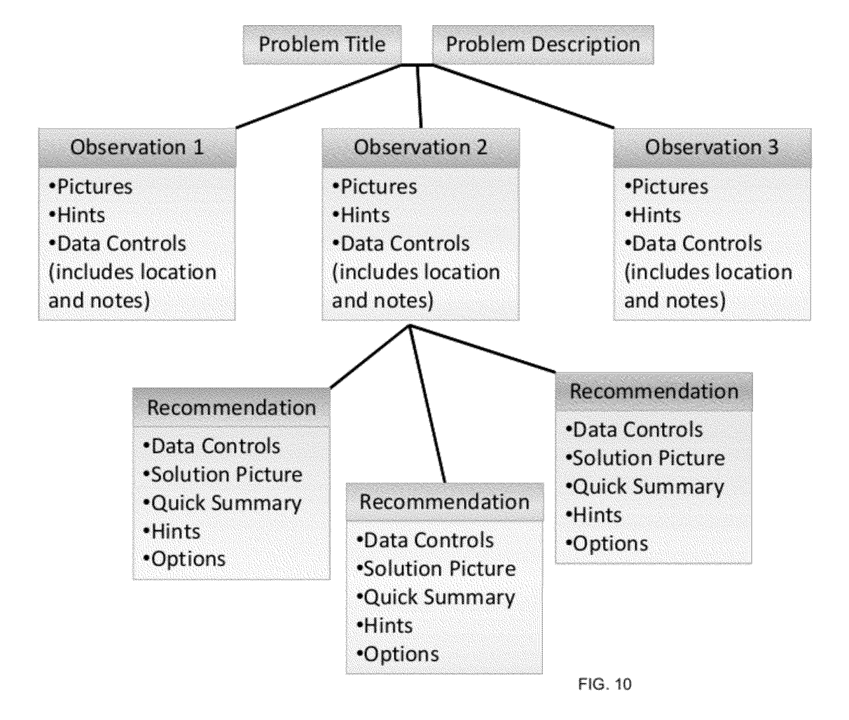

FIG. 11 is a diagrammatic view of the interactive structure of the digital library of problems and solutions with customized training and support.

FIG. 12 is a diagrammatic view of the interactive digital library of problems and solutions with customized training and support.

FIG. 13 is a screen shot of the DCI (Data Collection Interface) for a particular group of problem solution pairs on a portable electronic device or computer.

FIG. 14 is another screen shot of the DCI (Data Collection Interface) for a particular group of problem solution pairs on a portable electronic device or computer.

FIG. 15 is a screen shot of a Library Manager.

FIG. 16 is a screen shot of another Library Manager.

FIG. 17 is a screen shot of the Library Manager and the solutions recommendation options that can be paired up with different problem combination from FIG. 16.

FIG. 18 is a diagrammatic view of particular Building analyst user and how their library of problems and solutions structure can be integrated with a building contractor user for the purpose of creating an estimate/work order for the customer's home by the collaboration of the building analyst user and the home improvement contractor user.

FIG. 19 is a screen shot of Linking of Estimate Data Controls of a particular solution to specific program data or linking specific program data to the Estimate Data Controls.

FIG. 20 is a screen shot of Estimate Creation, word order output report, and data output automation builder/wizard.

FIG. 21 is another screen shot of Estimate Creation, work order output report, and data output automation builder/wizard.

FIG. 22 is a diagrammatic view of the integration of global program level defined problem and solution sets and company custom problem and solution data sets between different combination of collaboration between a building analyst and a building home improvement contractor.

FIG. 23 is a diagrammatic view of data controls provided by multiple building (home) contractor to one building analyst and a way of identifying which data controls belong to which contractor so the building analyst can create multiple estimates for one solution from multiple contractors and automatically deliver this information to the home owner.

FIG. 24 is a screen shot of Custom Report Creation Wizard for creation of both program level or contractor level customized reports.

FIG. 25 is screen shot of DCI Creation Wizard.

FIG. 26 is screen shot of Variables Creation/management interface.

FIG. 27 is screen shot of Data controls creation/management interface.

FIG. 28 is a screen shot of Library Manager on a Super Admin/Program level.

FIG. 29 is a screen shot of Payment module interface allowing for program level financial protocol definitions.

FIG. 30 is a screen shot of Customized user account builder.

FIG. 31 is a screen shot of Program/SubProgram/Statge structure builder interface.

FIG. 32 is a diagrammatic view of Organization of Jobs for a specific regional utility program.

FIG. 33 is a diagrammatic view of Assign Program Participation, filtering, and permission assignment options.

FIG. 34 is a diagrammatic view of external case (external iPad case), including a front elevational view and side elevational view of the external case.

FIG. 35 is a diagrammatic view of external case (external iPad case), including a front elevational view and side elevational view of the external case.

FIG. 36 is a diagrammatic view of external case (external iPad case), including a back elevational view and side elevational view of the external case.

FIG. 37 is a screen shot of Data Matrix Definitions interface.

FIG. 38 is a screen shot of a detailed interface allowing the user to use simple SQL commands to customize filters.

FIG. 39 is a screen shot of an interface that allows the user to customize the filtering and conditional settings of each variable.

FIG. 40 is a screen shot of the Data Matrix output interface.

FIG. 41 is a screen shot showing two (2) examples of different customized Data Matrix reports.

FIG. 42 is a screen shot showing the exporting feature of each report in the Data Matrix.

### DETAILED DESCRIPTION

### Definitions:

Property Record: A property record is the complete set of information related to a single address. It may contain numerous customers who live at that address over time.

Customer Record: A customer record is housed within a property record and is the complete set of information related to a customer, which may include multiple projects for different programs and subprograms. Customer records are the highest structure that the user sees in the web application. Customer records are what are displayed in the CRM overview pages (not jobs as it is currently structured in the Job Manager). Both Property and Customer Records sit on the cloud, and they are not specific to a company user account. Numerous different accounts can have access to the same records. However, the viewing and editing rights for the information stored within the record is set by the account that creates that information (to be detailed later).

Element: Elements are the different pieces of data/information that a customer record can hold. Each element has its own table in the SQL back end that is stored within the record structure. The types of elements that can be created for a record include:

Event: An event element contains all of the information regarding that particular including its time, location, property details, employee(s) involved, programs (if applicable), price, etc.

Data Set: A data set is the set of information that is collected by a user using the DCI. It includes data related to specific programs/modeling softwares (like Beacon), custom non-program related DCI variable, as well as all of the problems, observations, recommendations and all additional problem-associated data.

Workscopes: Workscopes will become the building blocks where users can input information contained within a Data Set and use it paired with company specific rules/logic to build estimates, proposals, work orders, invoices, etc.

Transactions: Transactions hold information regarding financial transactions. They are meant to be the same and as transactions in Quickbooks.

Communications: Communications are messages that are sent between a user and other project stakeholders including customers, partners, and other company employees.

Internal Documents: Internal documents are a visual representation of information stored within one or more elements. They are not an individual file or object, only a visual document that is viewed through a web browser. The templates for how these documents appear are setup in the Wizards available in the company setup menus or are programmed in the backend. Customer Reports and Sales Receipts are both examples of internal documents in our current system.

External Documents: External documents are files that can be uploaded into a record and/or the documents folder of an account. External documents will also include documents synced from a user's Google docs account.

| | | | |
|---|---|---|---|
| Structure and Nomenclature of Jobs: e.g. | BGE | LIEEP | Audit |
| | Pepco | HPwES | Test Out |
| | Pro- | Sub- | Stage |
| | gram | program | |

Program: Programs refer to the main utility or program administrator that runs a Homes Performance program. If the program administrator also uses the gREATESST admin application to run their program, the Program choice is what determines which information within a customer record is shared with that administrator's admin application account. The Program delineation also serves as a way t visually organize a larger list of subprogram.

Subprogram: A subprogram refers to the actual program that a job or project is in. Consequently, when we refer to a “project” or a “job” we are also referring to the associated subprogram.

Stage: The Stage refers to the different stages that make up a subprogram as a project progresses from start to finish. All information within record elements that are associated with a particular subprogram are structurally linked to a stage. The start of a stage is triggered by the creation of an event that is specified to relate to that particular stage.

Status: The status of a stage is a way for users to further specify the exact status of a project within their own company's process. The status has no structural significance, its merely a user defined characteristic of a stage.

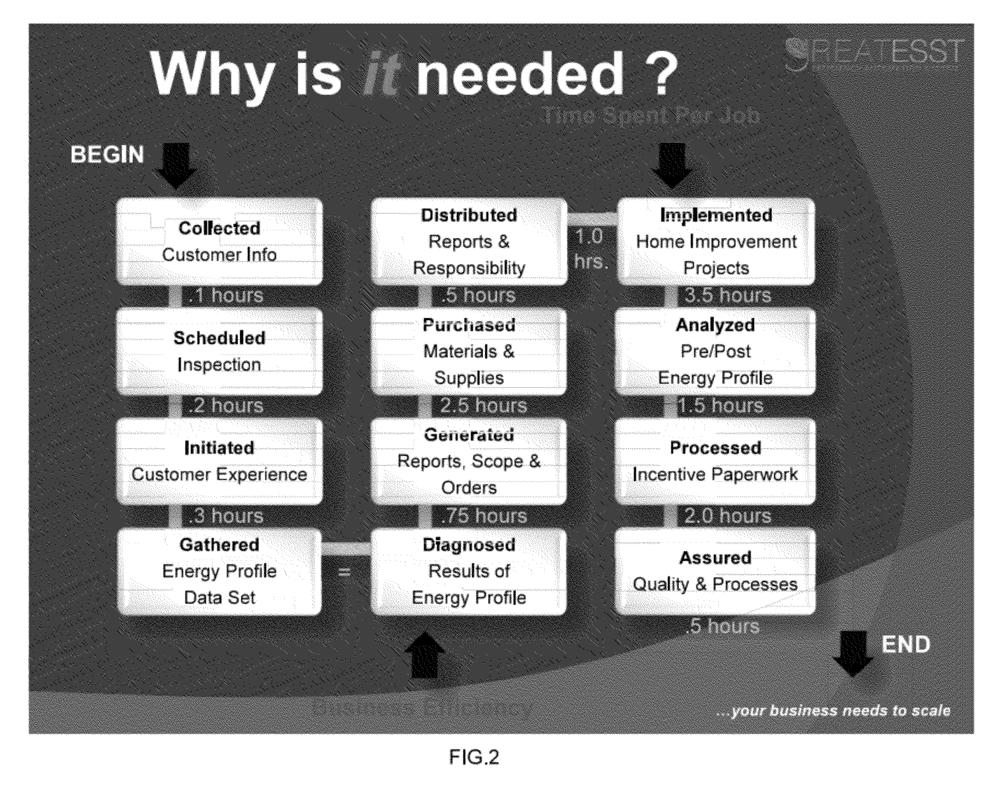

The system and method comprises multiple steps. A flow chart of steps for the system and method are shown in FIG. 2.

The system and method comprises the steps of:
1) Collecting customer information;
2) Scheduling an inspection at the property or building;
3) Initiating customer experience;
4) Gathering energy profile data set;
5) Diagnosing (auditing) results of energy profile data set;
6) Generating reports, scope and orders;
7) Purchasing material and supplies;
8) Distributing reports and responsibility;
9) Implementing home improvement projects;
10) analyzing pre/post energy profile;
11) processing incentive paperwork; and
12) assuring quality and processes.

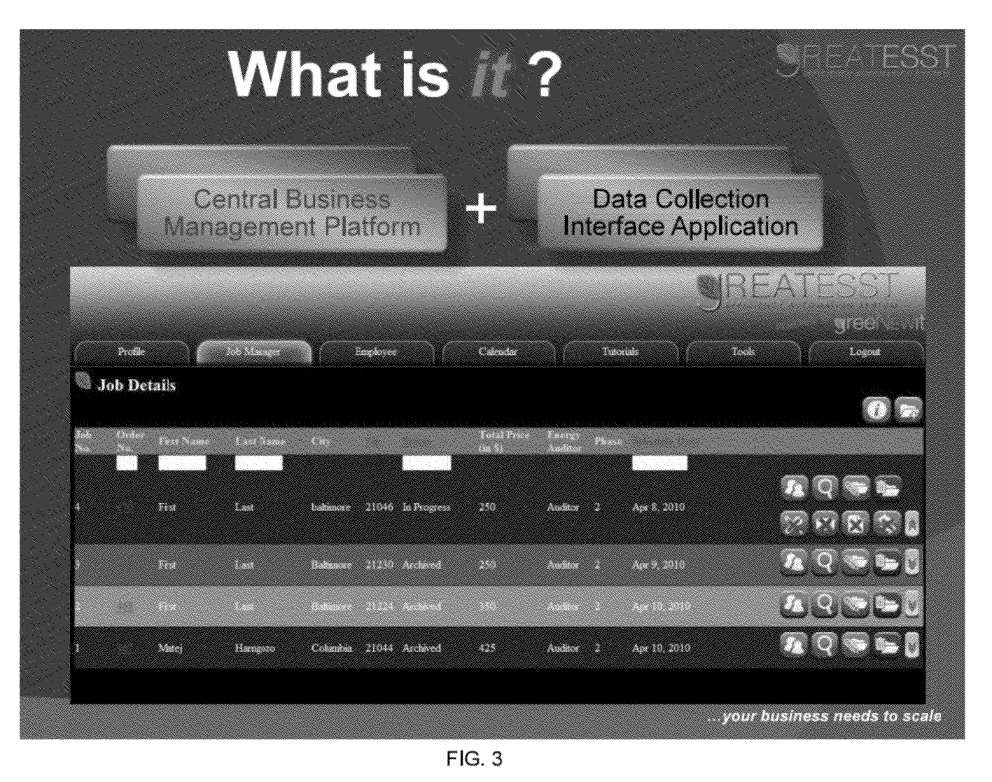

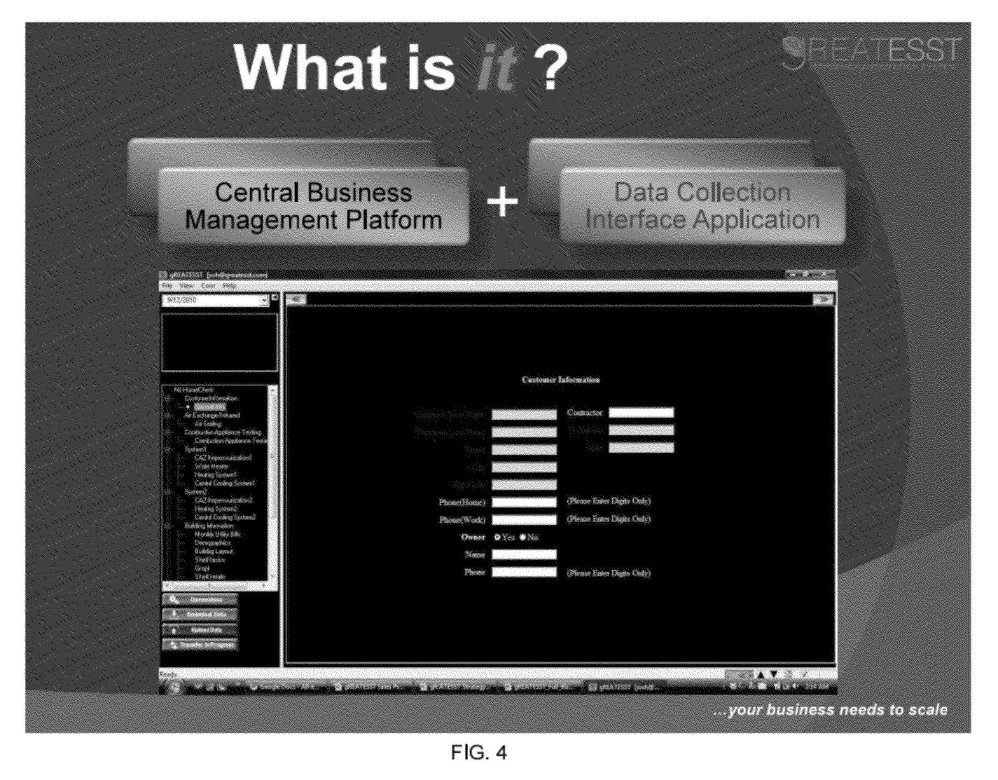

The system and method comprise a central business management program and a data interface application, as shown in FIGS. 3 and 4. These screen shots provide for collecting customer information.

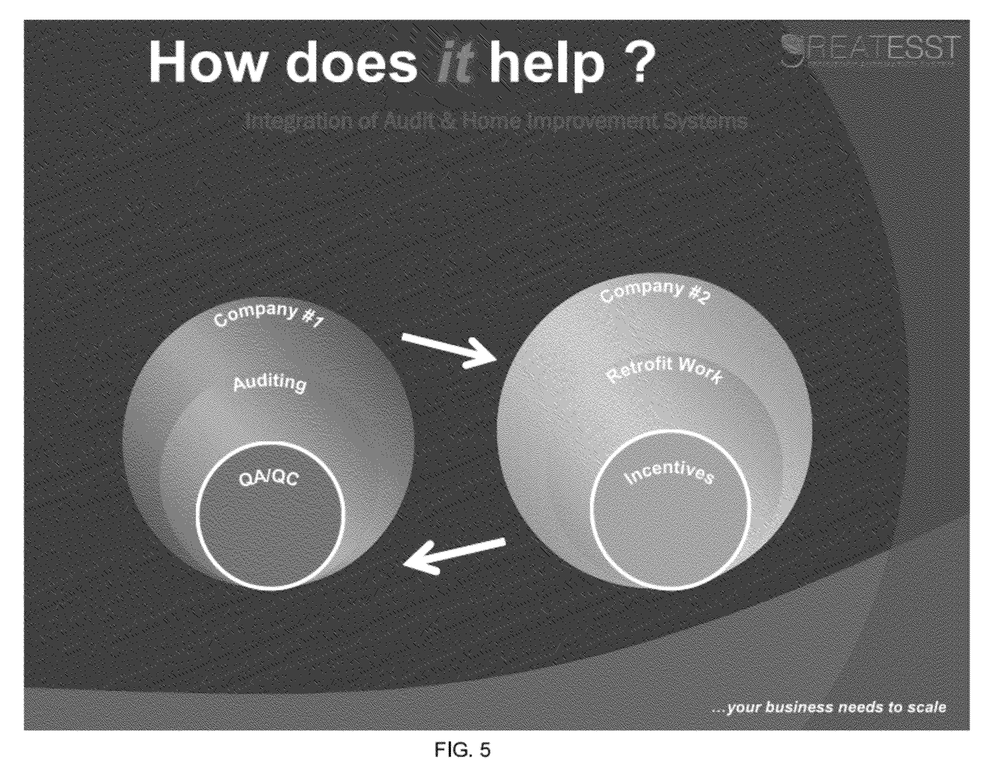

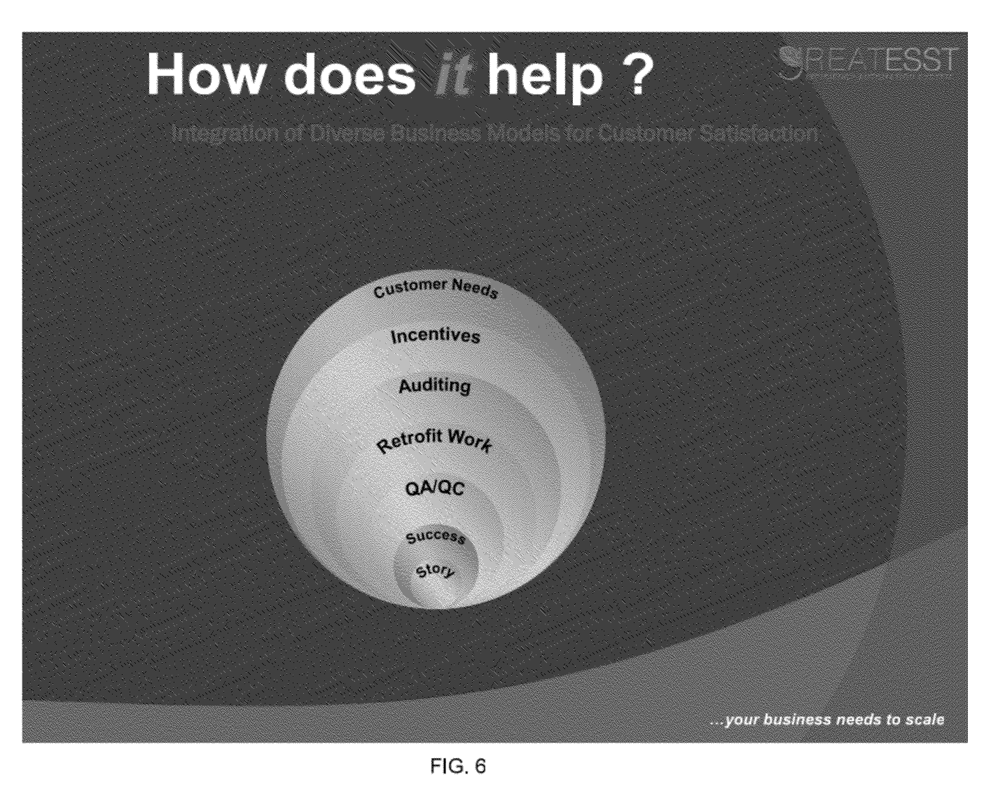

The system and method also provide the integration of audit and building improvement systems with company #1 conducting the auditing and QA/QC and company #2 conducting the retrofit work and incentives, as shown in FIG. 5. In addition, the system and method provide integration of diverse business models for customer satisfaction taking into account customer needs, incentives, auditing, retrofit work, QA/QC to provide a success story, as shown in FIG. 6.

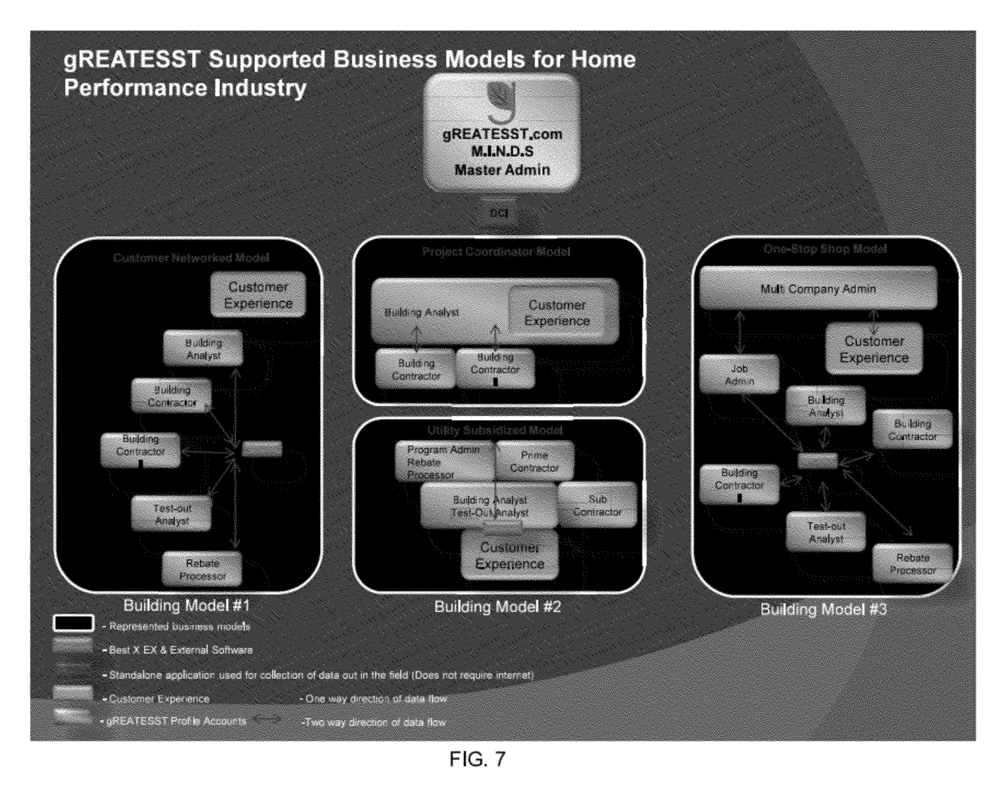

Supported business models for the building (home) performance industry is shown in FIG. 7.

The DCI is a stand alone application used for the collection of data out in the field (i.e. does not require Internet).

Building model #1 provides for customer experience, building analyst, building contractor, test-out analyst, and rebate processor as Best X EX & External Software.

Building model #2 provides for a building contractor I, building contractor II, and building analyst working together with a prime contractor, sub contractor, building analyst test-out analyst, and program administration rebate processor.

Building model #3 provides for a multi company admin, job admin, building analyst, building contractor I, building contractor II, test-out analyst, and rebate processor.

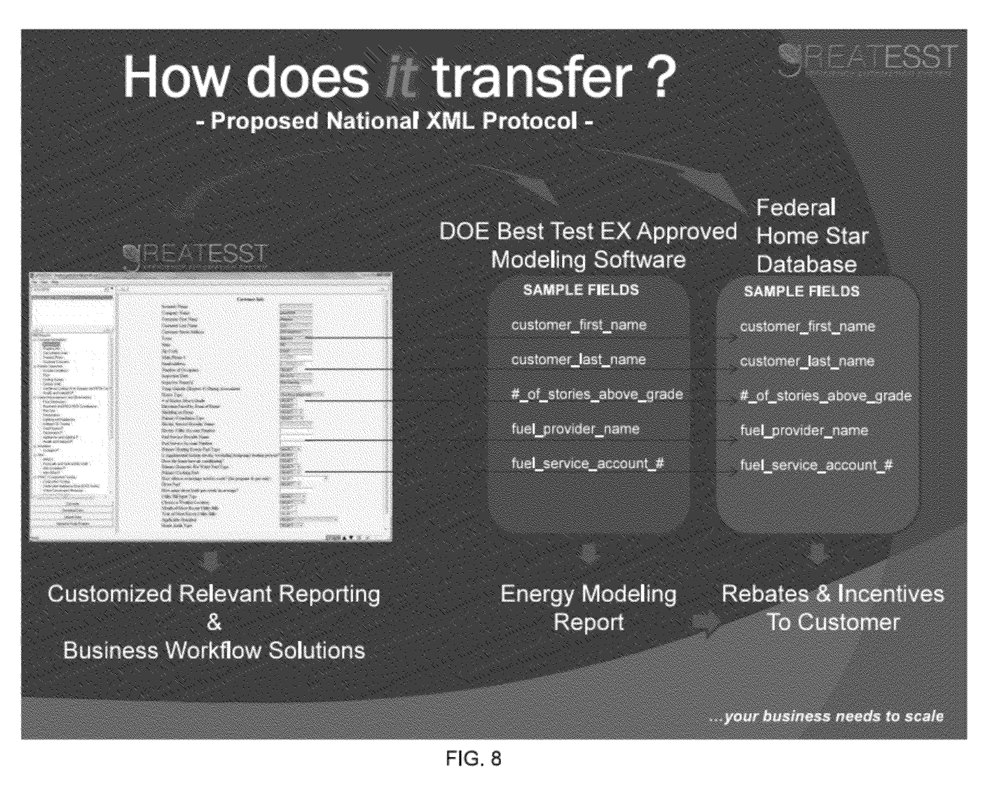

The system and method provide integration to allow sharing information outside vendors and their software and databases, as shown in FIG. 8. For example, data including the customer's first name, customer's last name, number of stories above grade, fuel provider name, and fuel service account number. This integration reduces time and redundant efforts to obtain and use data in the system and method.

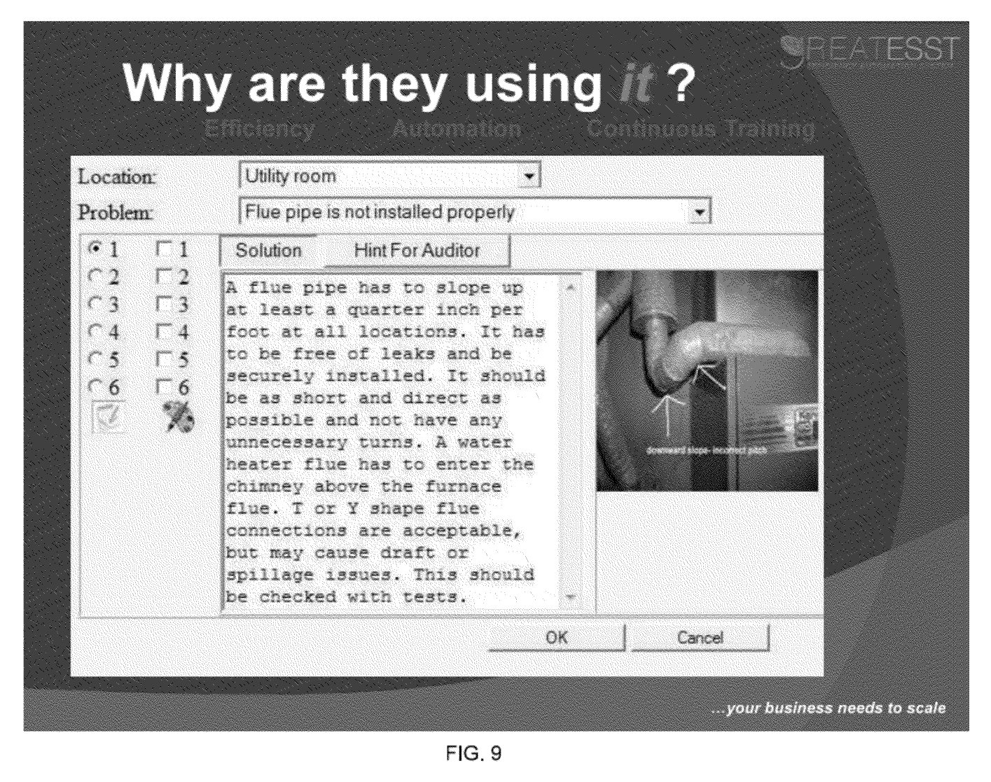

The system and method also provide for efficiency, automation, and continuous training as illustrated in FIG. 9. The user collecting data is provided with access to training information from outside vendors that can be brought to bear on data collection and auditing. This is a valuable resource tool.

The system and method provides for a number of features, including:

I. Interactive Digital Library of Problems and Solutions with Customized Training and Support
industry training through problem and solution library with custom company protocols with pic, audio, video or text
live video quality assurance in the field
   II. Estimate Creation Wizard with Report Output Integration and Quickbooks Integration
estimation creation wizard connection to suppliers based deals advertising based on data collection.

### III. Modular Administration Program Build Out

programs/subprograms/stage structure build out
specific data collection interface buildout and management wizard
specific report output creation wizard
modular financial/payment structure wizard
permission/filter based user account creation wizard
automatic tiered report outputs based on permissions

### IV. Energy Audit Lead Valuation System

taking third party data sets that have close relation to the energy efficiency/retrofit or real estate data requirements and evaluating its worth for potential expansion on this data
assigning lead valuation through the creation of partial or full home improvement data sets for industry specific data collectors based on industry improvement standards
   V. Real time Quality Assurance Dispatching
   VI. Rugged External iPad Case with IR Digital Camera with Flash, Video Conference Capability, Laser measurement Tool for 3D Building (House) Modeling Applications
   VII. Dynamic Data Matrix with GUI to an MySQL Database Through an Linux Environment

The details of each of the above features is explained in detail below. The system and method can incorporate one or more of these features.

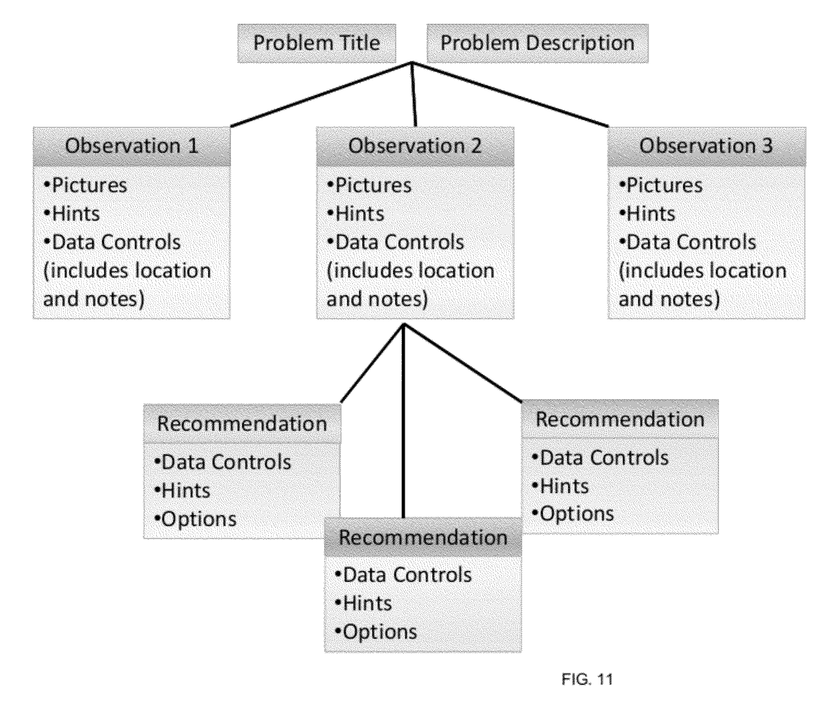

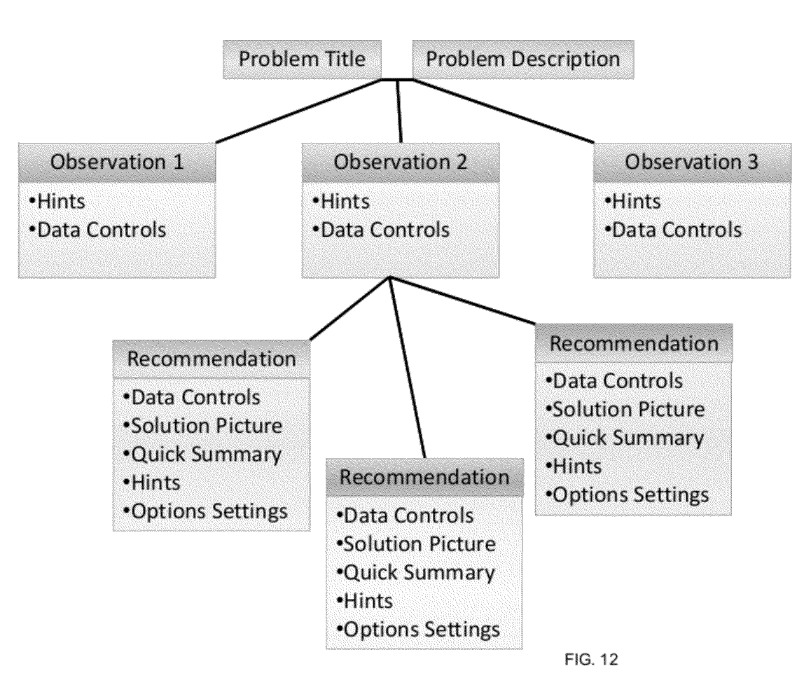

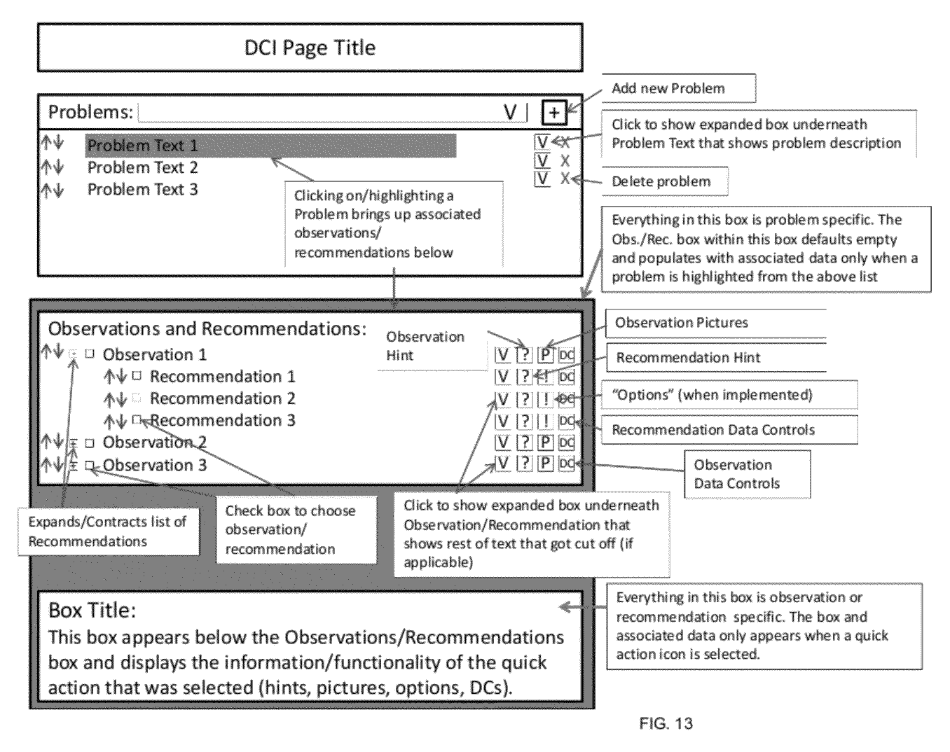

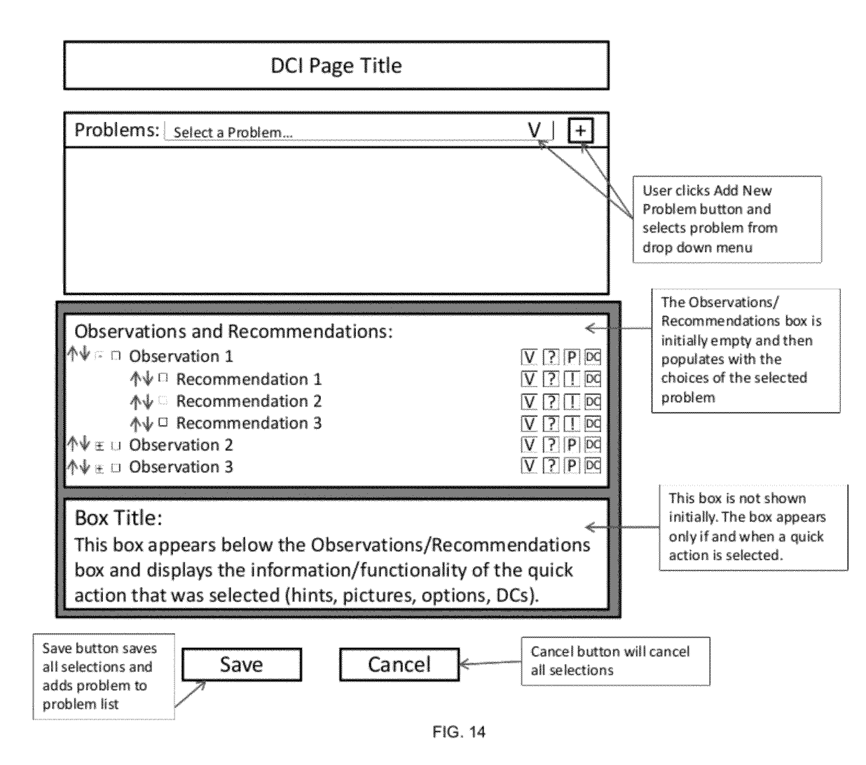

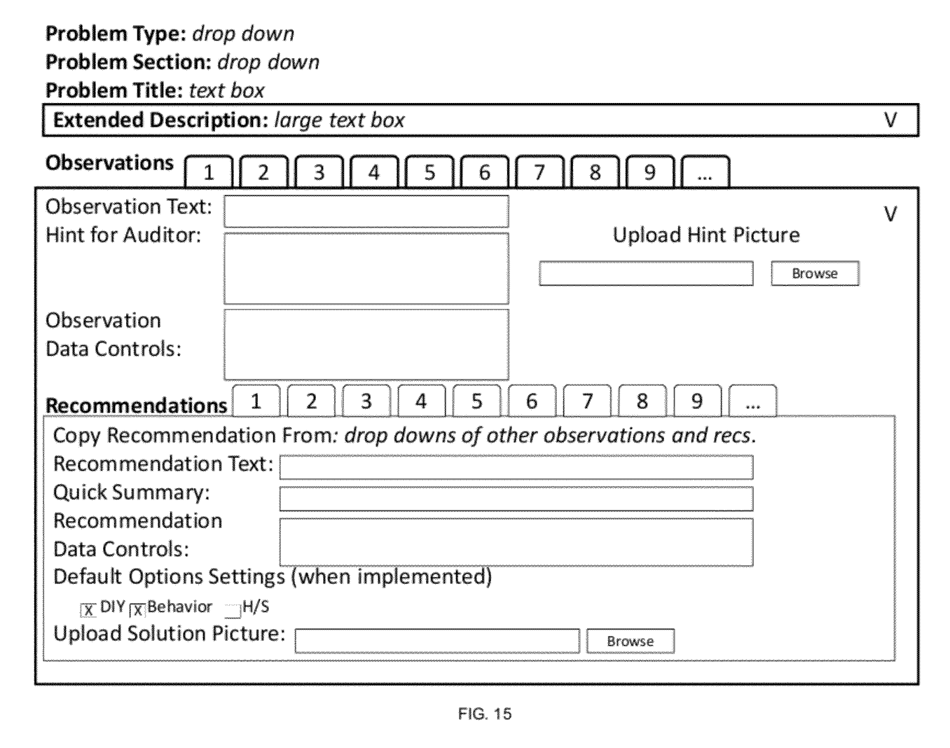

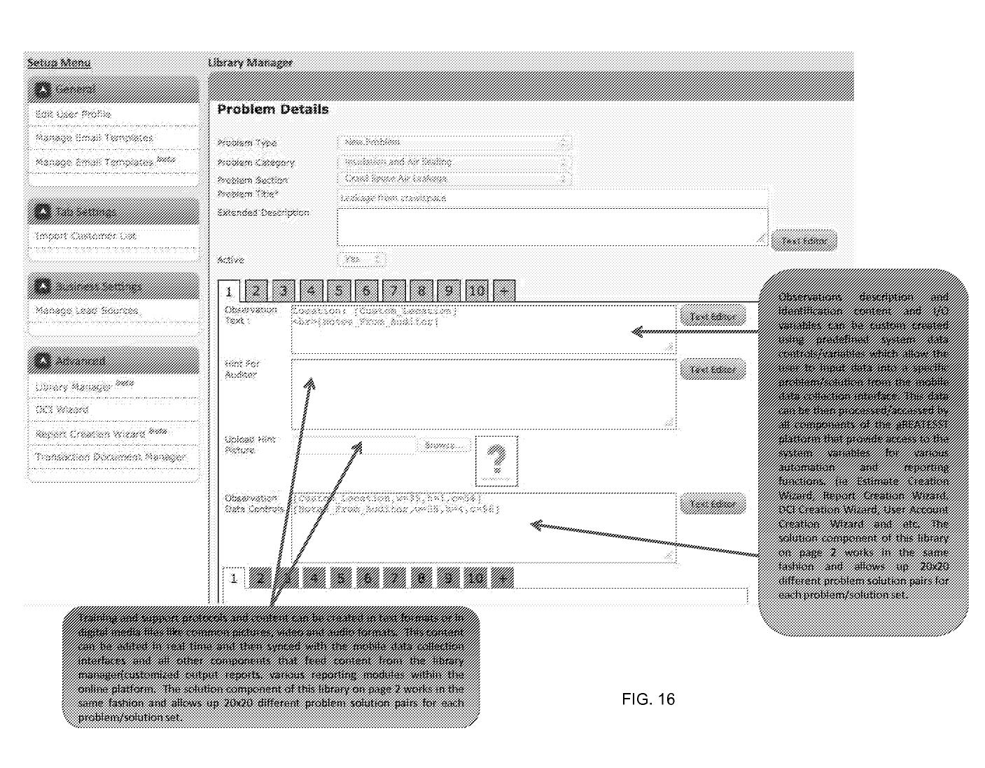

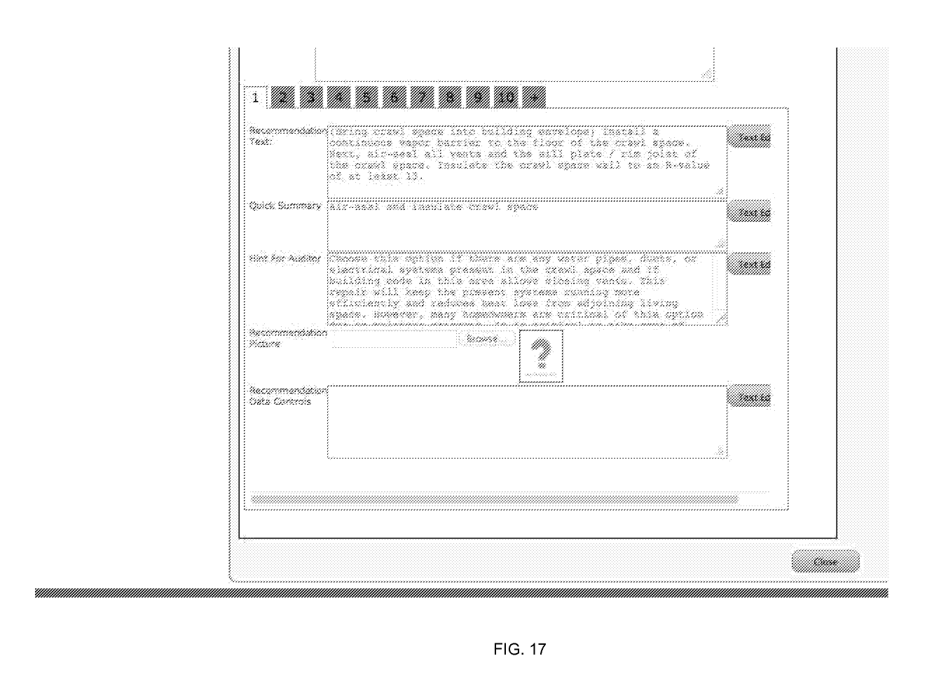

I. Interactive Digital Library of Problems and Solutions with Customized Training and Support (FIGS. 11-17)

This feature allows all types of home (building) improvement contractors, home energy improvement contractors, and real estate home inspection contractors to create a digital library of commonly identified/used problems, solutions, energy auditing protocols, home improvement retrofit protocols, service packages, training and support protocols. This also allows Energy Efficiency program administrator to build out the same type of libraries for the use of the program specifications and make them available to all third party users(e.g. generally contractors participating in the program) of the platform. The problem solution sets also provide a creation/editing wizard to all levels of users in the platform (Super-Admins, Sub-Admins, Contractors). Please see the Powerpoint file “ProblemSolutionLibrary.pptx” and images of the data types and I/O content modules that exist within the Library Manager's creation/edit wizard. All content can be accessed and processes by any components in the gREATESST platform that will utilize this data for various automation, collection and reporting functions. Some examples of these components are the Estimate Creation Wizard, Report Creation Wizard, DCI Creation Wizard, User Account Creation Wizard, Inventory Management Wizard, Communication Automation Wizard and etc. The DCI, especially, is designed to fully integrate with the problem/solution sets and provides a GUI (graphical user interface) to the user allowing full access to the customized I/O content, and data collection. Please see the Powerpoint file “P_Library_Restructure_v2.pptx” for further visual details of the integration between the Library Manager and the DCI.

The library manager can also be used to build out existing industry knowledge bases on the program administrative level and provide them digitally to the users in the field through the gREATESST DCI component. Examples of such industry knowledge bases are the BPI standards and protocols, RESNET and Energy Star standards and protocols, AHRAE Standards and others. Data inputs that are entered through the DCI using these problem/solution can be accessed or processed through many different filters and permission levels including national/regional, program, and individual real estate property level.

The current extension that is being built out to this library component is the live video support/training conferencing component. This will allow a network of educators, program support personnel, industry expert personnel, quality assurance personnel and etc to be linked to individual problem/solution sets, or whole categories of, to be available for on demand video conferencing and support. The actual video conference would be done on a mobile device that has the gREATESST DCI(Data Collection Interface) installed and running, providing it has a front facing video camera in the mobile device.

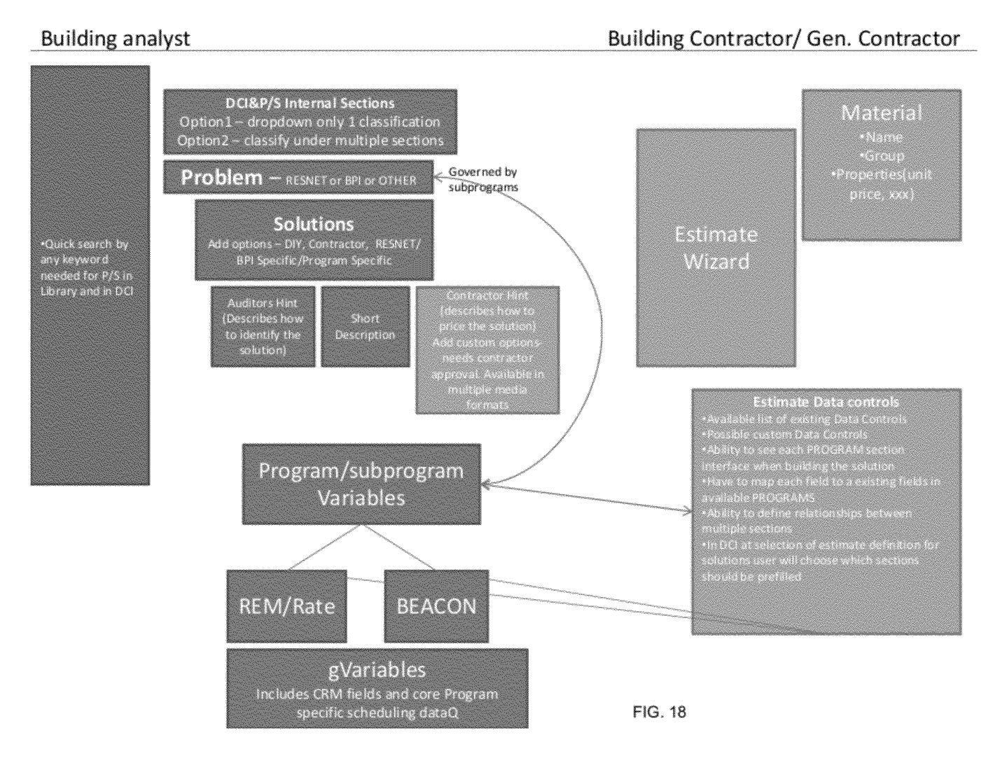

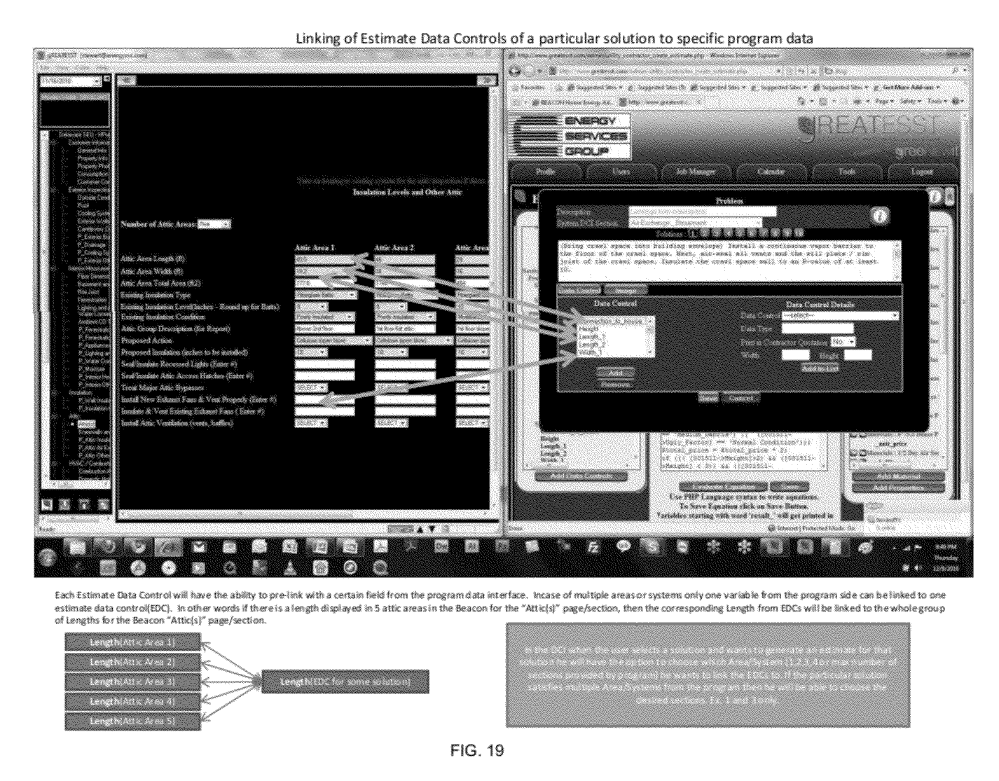

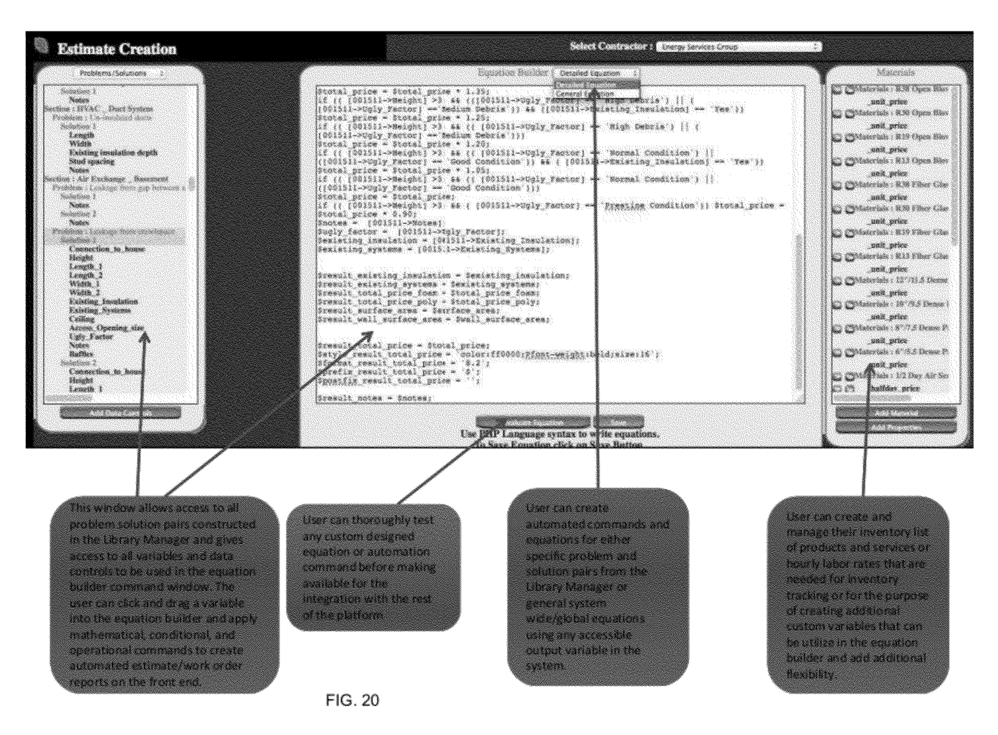

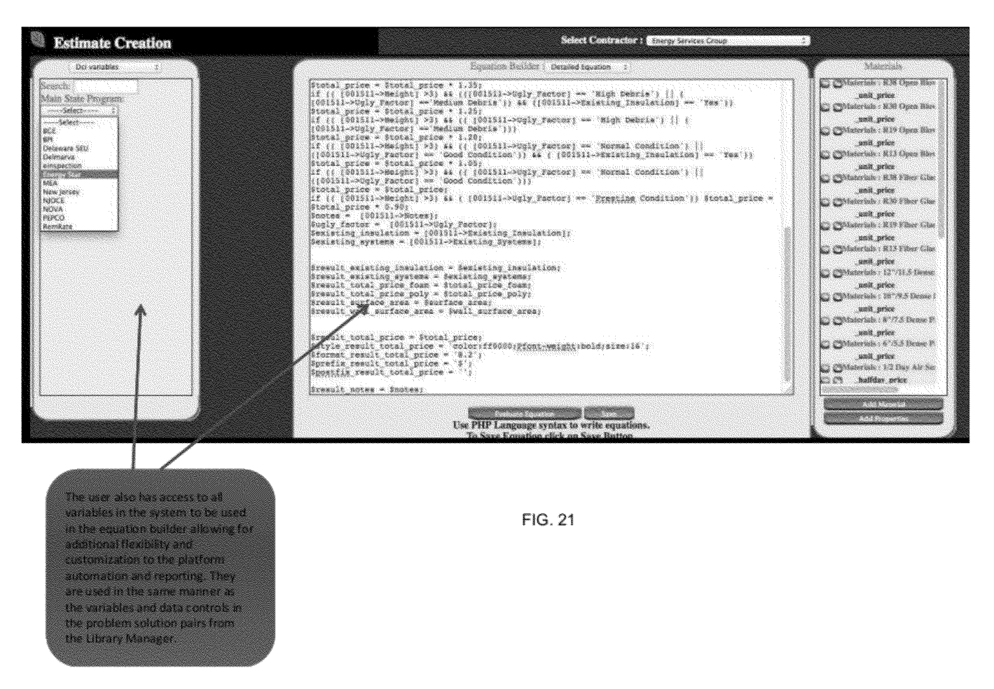

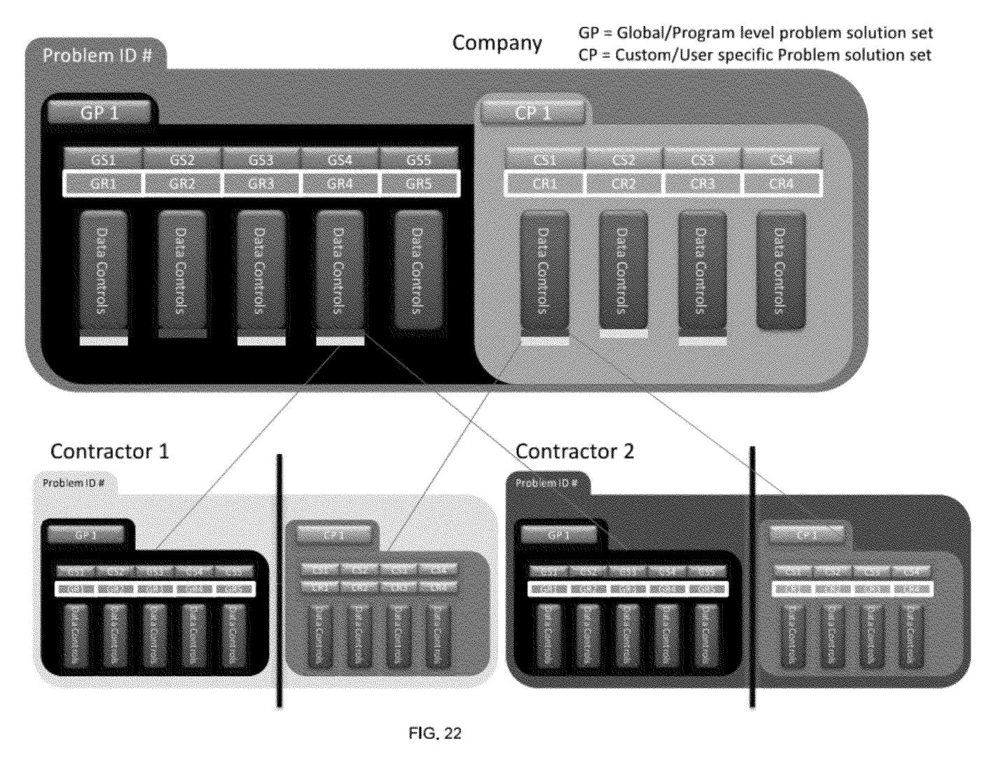

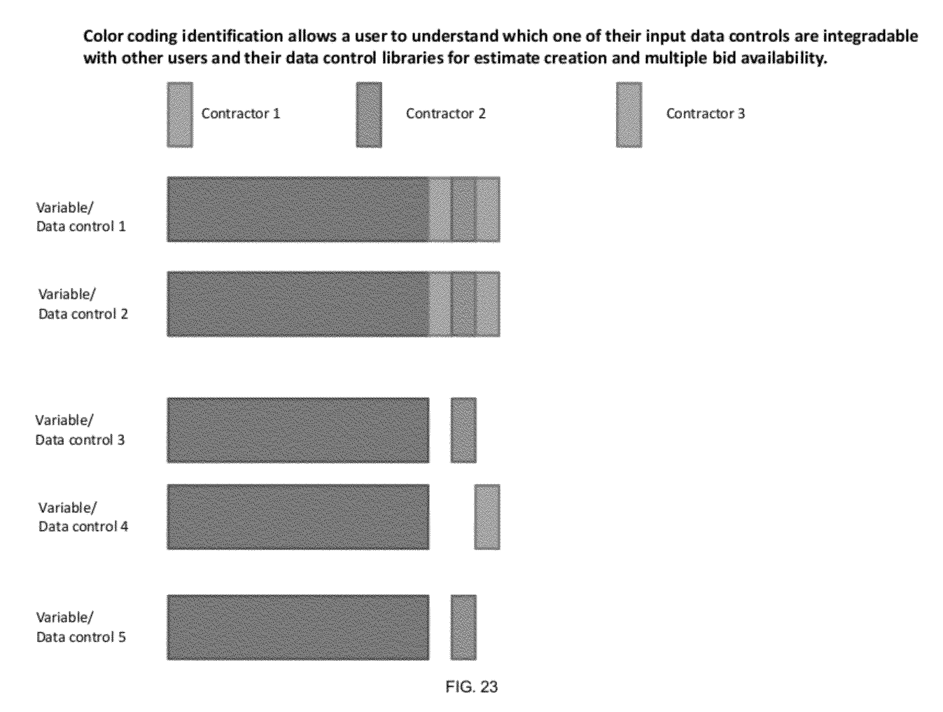

II. Estimate Creation Wizard with Report Output Integration and Quickbooks Integration (FIGS. 18-23)

The estimate creation wizard allows for full customization of creating residential/commercial property energy improvement work orders/estimates, residential/commercial general improvement and services work orders/estimates, inventory management with supplier integration and third party bidding and subcontractor collaboration environment. In detail the estimate creation wizard allows the users of the gREATESST platform to:
create and manage an inventory list of products and services offered;
API integration to QuickBooks financial/accounting software and CSV, and Excel data export;
API integration to third party suppliers for automated inventory alert, ordering, and advertising;
proprietary equation command line module providing a fully customized estimate and financial algorithm environment allowing users to automate estimate/work order generation;
allows for integration and automation of customized estimate and financial user specific algorithms to be integrated with third party users for subcontracting purposes and management;
multiple bid output feature allowing customers to choose between different pricing options from different sources/subcontractors; and
full integration with the Library Manager.

Enhancements to the proprietary command line included standardized mathematical, conditional, and operation commands for ease of algorithm creation and usability. Currently the commands can be coded in full PHP software language or a currently simplified list of common mathematical and conditional commands specifically created for the use of the estimate creation wizard.

Please see additional diagrams and visual representations of this functional prototype in the Powerpoint files:
“audit_contractor_integration_diagrams_using_estimate_creation.pptx” explains how the Estimate Creation integrates with other components of the software like the DCI, Problem solution library and Program level specific variables and data controls; and
“Multiple_bid_user_integration_visual.pptx” explains how the different user can integrate the multiple bid Estimate Creation feature through certain front end features during data collection processes.

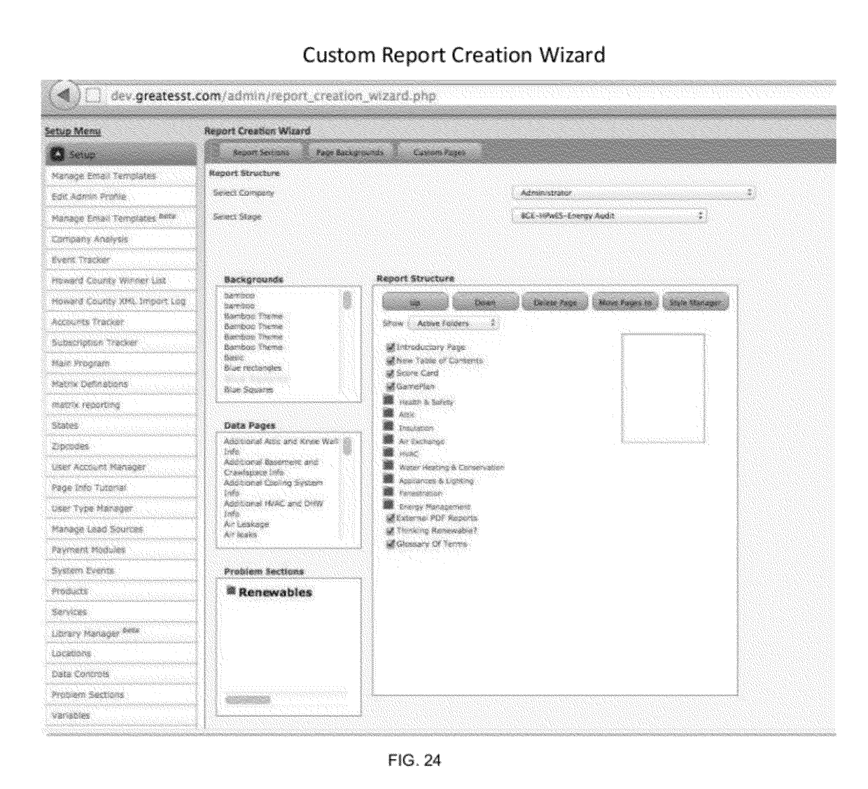

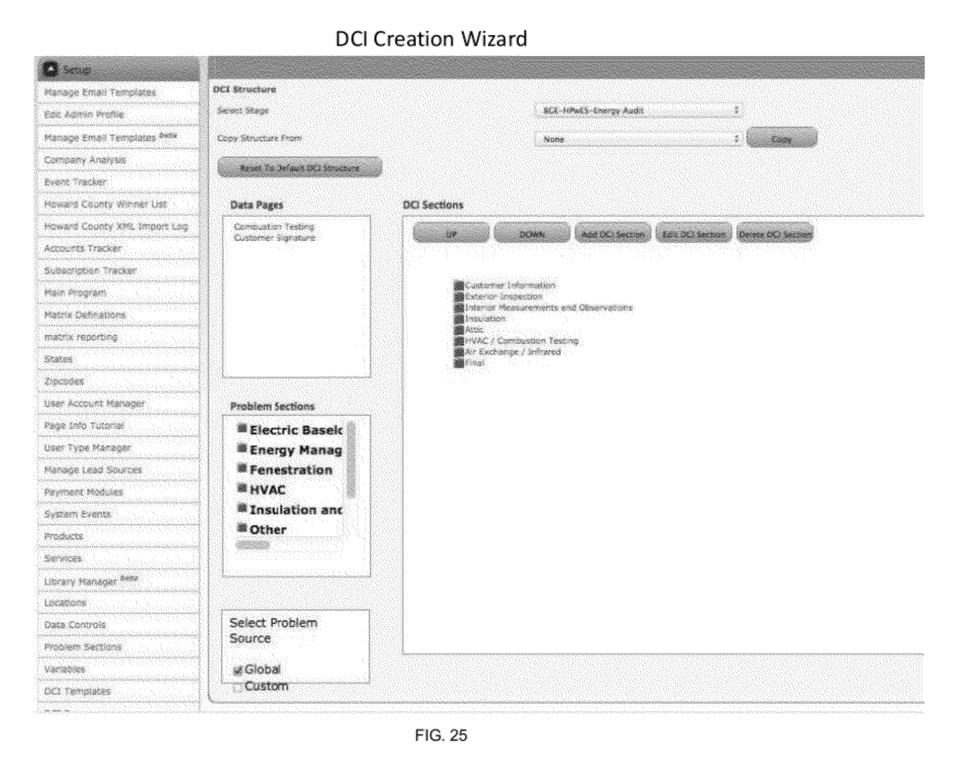

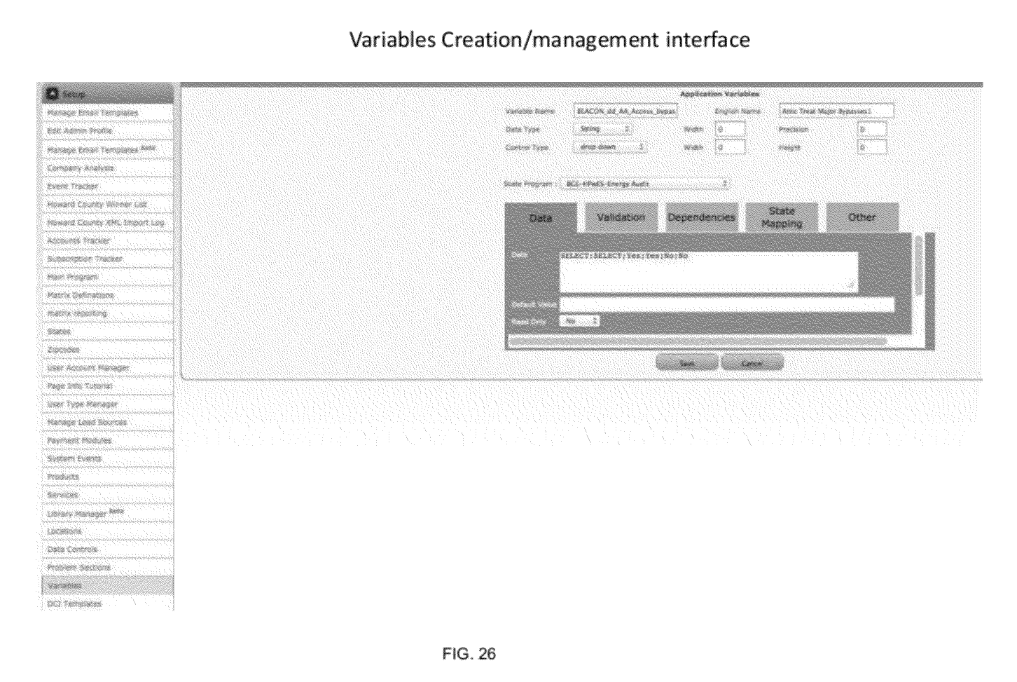

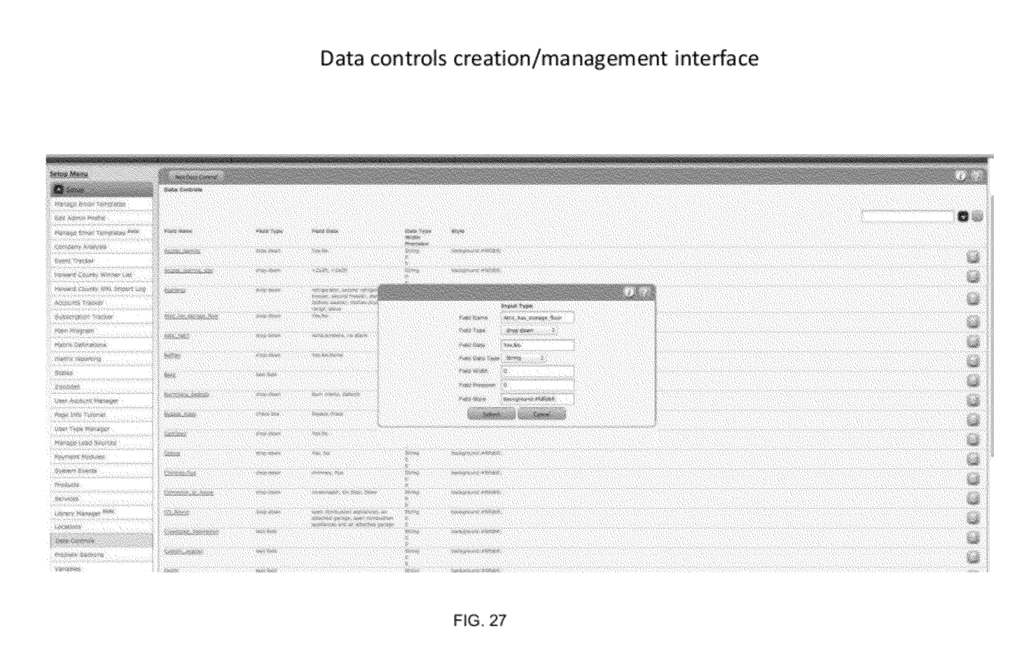

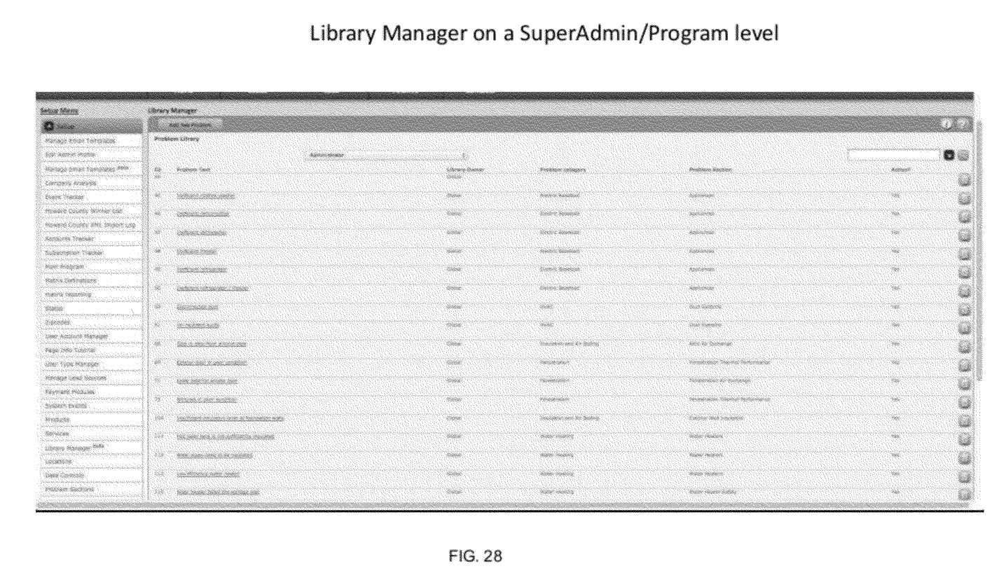

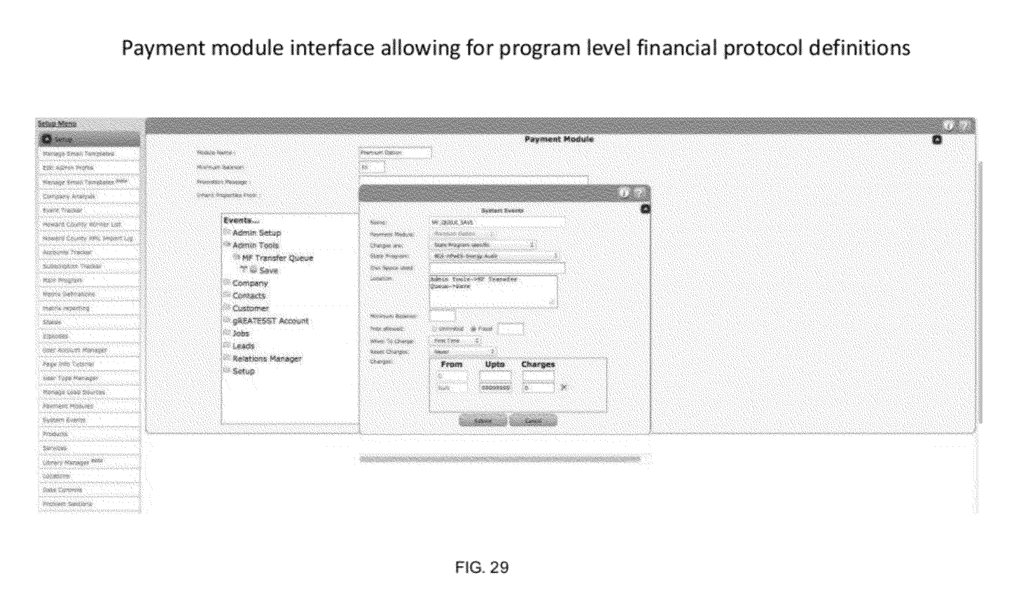

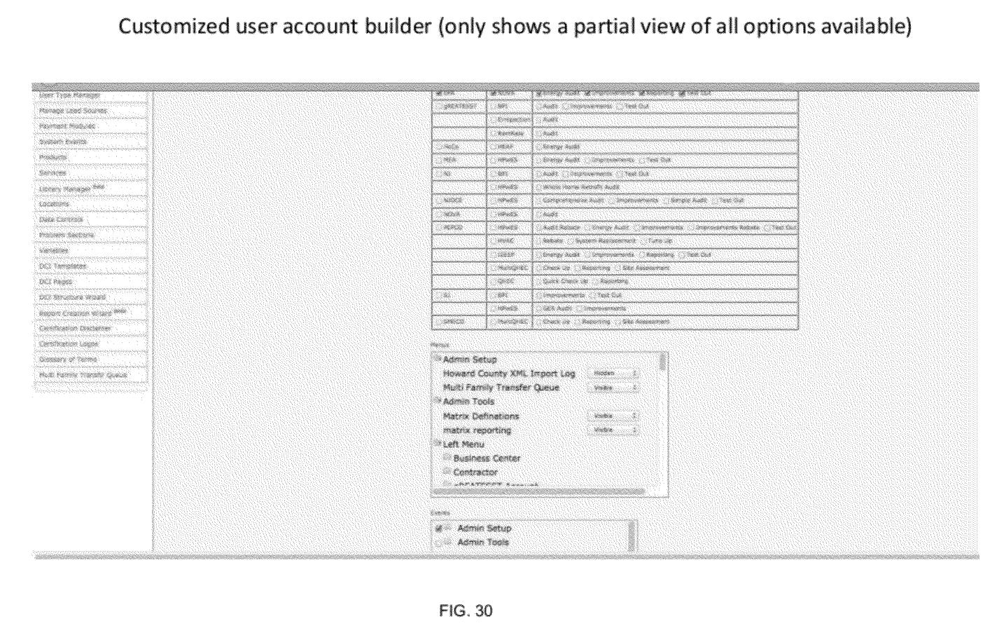

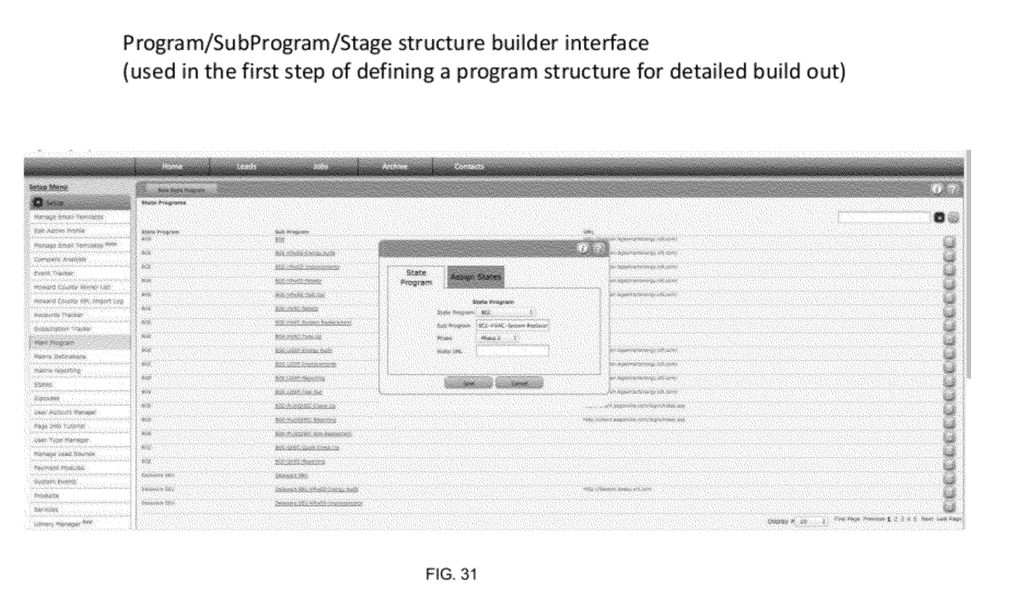

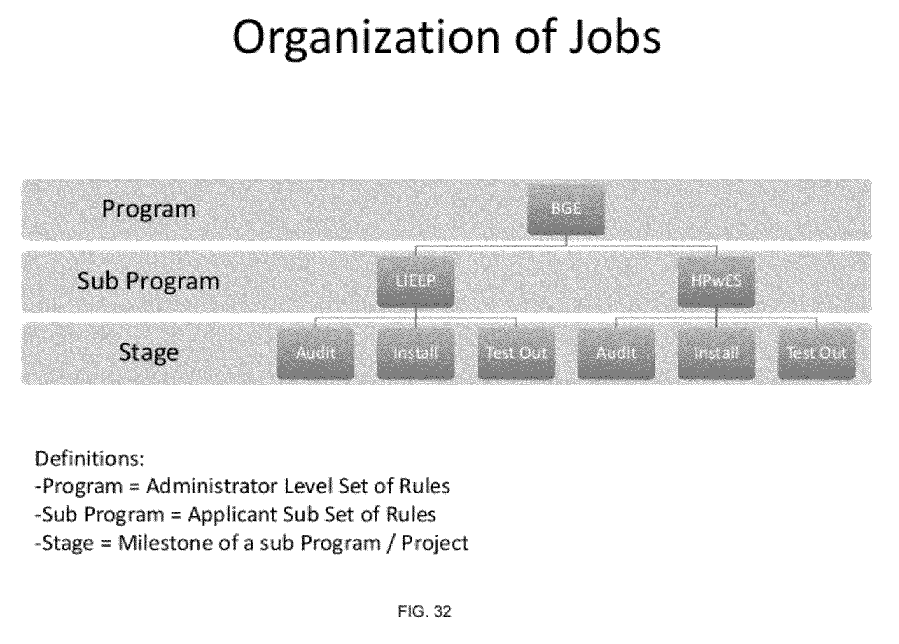

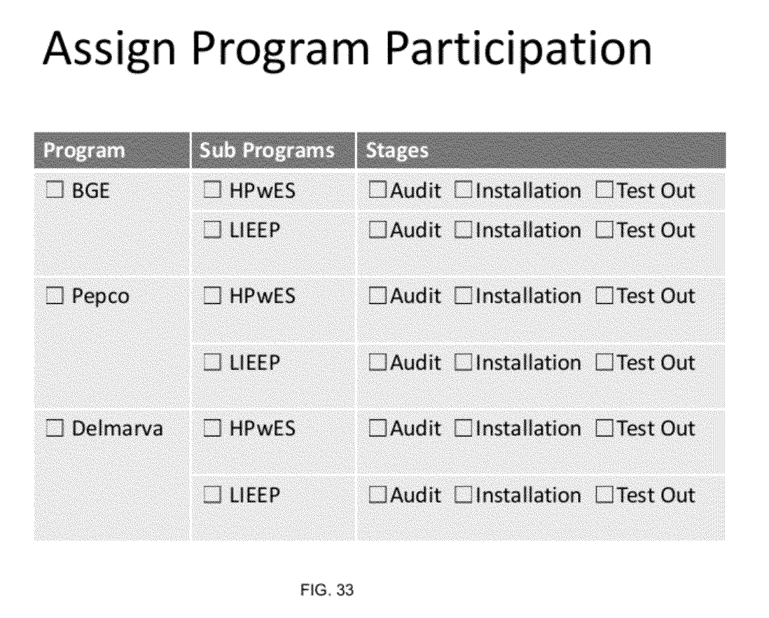

### III. Modular Administration Program Builder (FIGS. 24-33)

The Modular Administration Program Builder feature allows the gREATESST platform to build a specific Program level operating platform and being able to cater to, customize, streamline, and automate all requirements of such Energy Efficiency/Retrofit Programs. The program builder first needs to identify and set up the different levels of protocols, processes, steps needed to fully administer and streamline a particular program and integrate all required 3rd party users into its operation. The gREATESST platform does this by creating a Program/Subprogram/Stage operational structure where further operational details and processes will be designed and deployed using the Program Builder.

Once the above mentioned requirements are collected and identified and constructed in the platform various DCIs(data collection interfaces) are built to streamline the data collection, communication and output needs of the program and all of its users.

Next step is building out specific customized reports that can be generated by different user of the system using the Report Creation Wizard. These report outputs are fully integrated with the key features of the gREATESST Platform like the Digital Problem Solution Library Manager, the Estimate Creation Wizard, and any DCI available for a particular program buildout. These reports are available to different users of the system by being able to define filters and permission settings to specific user accounts and properly integrate with the earlier defined Program/SubProgram/Stage structure and operation flow. For example the quality assurance portion will only have access to certain reports where the third party contractor accounts will not have access to such reports and etc.

Another feature of this modular program level builder is being able to define payment and financial protocols and functions. This allows the gREATESST System to charge for different functions of the system and define how the charges will be processes. For example certain function can be prepaid or unlimited to the users for a flat fee, some can be charged on a per use basis, or the system can provide a customized combination of both methods.

The unique feature of this Program Platform Builder is that these modular methods and components are built and customizable from a front end GUI and only require little to no software coding knowledge and rigorous alpha and beta testing prior to program deployment. Please see the following Powerpoint and pdf files for visual explanation and screen shots of the actual Program Builder components:
“Software_Structure_and_data_processing_flow_UTILITY MD.pdf” shows a sample program structure and dataflow between all different user accounts and components;
“Program Organization.pptx” shows the backend software organization of how a specific program breaks down and how its organized into specific Program/SubProgram Structure;
“data_processing_flow.pptx” shows another possible program structure that can be built out using the Program Builder functionality; and
“program platform builder steps live screenshots.pptx” shows various live screenshots of all the different features and functions needed and used to customize a program administration platform environment for energy efficiency/retrofit programs.
   IV. Energy Audit Lead valuation System

This feature involves taking third party data sets that have close relation to the energy efficiency/retrofit or real estate data requirements and evaluating its worth for potential expansion on this data.

For example, a Home Inspector using the gREATESST platform collects all data related to a home inspection electronically through the DCI. Once that data sync to the server, it can be then be processed and compared against master industry database tables for similar inputs. Once like variables are identified they can be run through the system Lead evaluation algorithms to place a value on the packaged lead dataset file. The variables that are needed for various levels of evaluations, include:
first name
last name
address, city, state, zip
property type (red)
year built (red)
ambient shading
square footage (red)
number of occupants
appliance types
insulation type
insulation amount
number of windows & doors & types
fuel types (green)
utility usage for the last 12 months (green)
heating degree days (red)

The data points shown in (red) can be extracted from publicly available databases like the SDAT for (property type, year built, square footage) and various weather data providers for the heating degree days data. The data point in (green) can be collected by the home inspector, provided by the customer themselves OR a “green button initiative.” See http://www.greenbuttondata.org/. The green button method will allow for instant energy usage data extraction on any property with the customers approval. Having the utility usage data for the last 12 months of a residential property along with all other data points specified above allows for the highest valuation of a lead data package. Once the data is packaged into a lead, other gREATESST users will be able to bid on this lead internally.

assigning lead valuation through the creation of partial or full home improvement data sets for industry specific data collectors based on industry improvement standards

For external valuation and distribution of these valued lead source another online platform (new website) will be developed allowing any industry data collector, that can provide a subset of the data mentioned above, to upload it into this website and get their data sets valued. Once valued it will be made available on this website as a biddable product so that other industry subscribers of this service can then bid on and purchase this packaged customer lead. In a sense this is a lead marketplace specific to the energy efficiency industry. Future expansions of this service will focus on other industries that have multiple related markets and data collectors where their individual subsets can be valued and sold among the like industry participants and subscribers of that service.

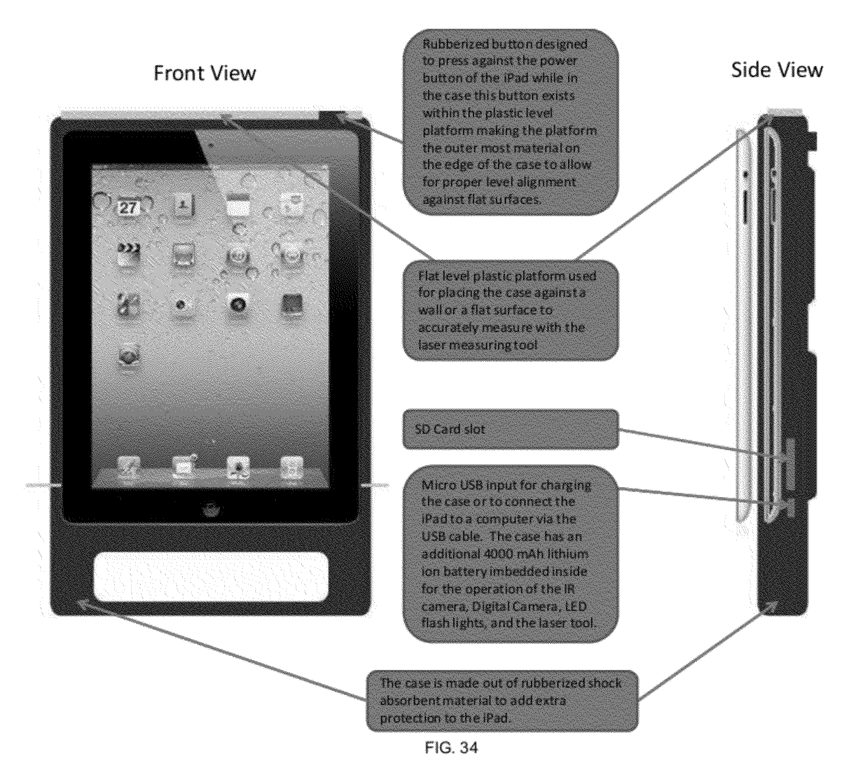

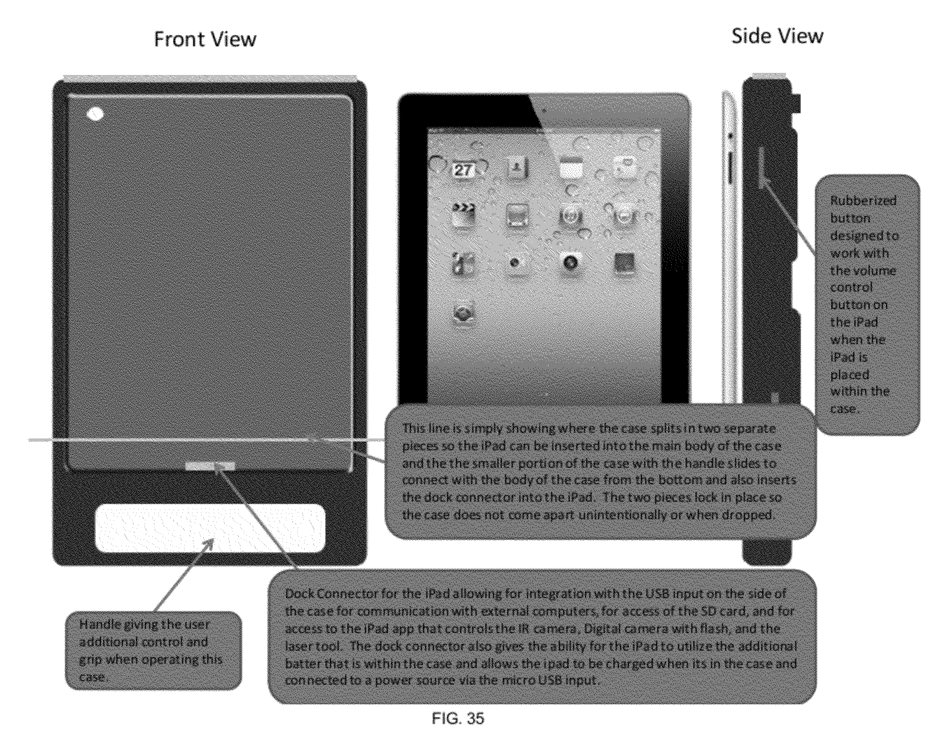

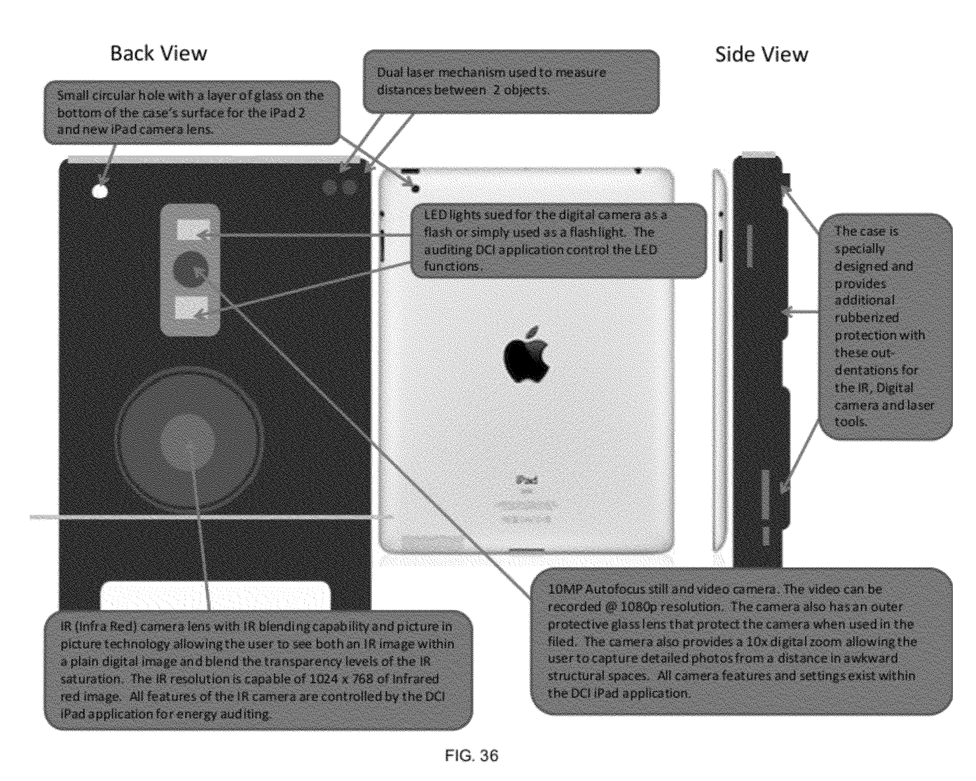

V. Extended ipad Case with IR Camera, Digital Camera with Flash, Video Conference, and Laser Measurement Tool for 3D House Modeling Application (FIGS. 34-36)

When an auditor is in the field and a full comprehensive diagnostic energy audit needs to be performed generally multiple tools need to be used. The auditor needs to be able to capture detailed pictures of problematic areas to provide detailed recommendations on energy retrofit improvements. An infrared camera is also used to identify air leakage within the property or any other temperature difference problems. IR camera can also be used to identify overloaded breaker fuses in a electrical box by seeing how hot each breaker lead/fuse is. For these diagnostics auditor generally need to carry and infrared camera, a separate digital camera with good zoom features and separate industrial size flashlights when inspecting the attic, crawl spaces or other dark areas of the home. The auditor also needs to collect detailed measurements of the property dimensions. This can either be performed manually by using a measuring tape, which many times requires two people for long distance and awkward spacing or a laser measuring tool can be used the take quicker more accurate measurements between any two (2) given objects.

The external iPad case provides all of these tools in one. The iPad DCI application controls the additional infrared camera, hi zoom digital camera, 2 powerful LED flash/flashlight components, and the laser measurement tool. The case also provides additional protection for the iPad with its unique shock absorbing rubberized material that the case is built out of. An extra 4000 mAh lithium ion battery also exists within the case to provide separate power to these components or to provide and extended battery source to the iPad. Please see the Powerpoint file “Energy Auditing iPad addon case.pptx” for additional details, design and visual representation.

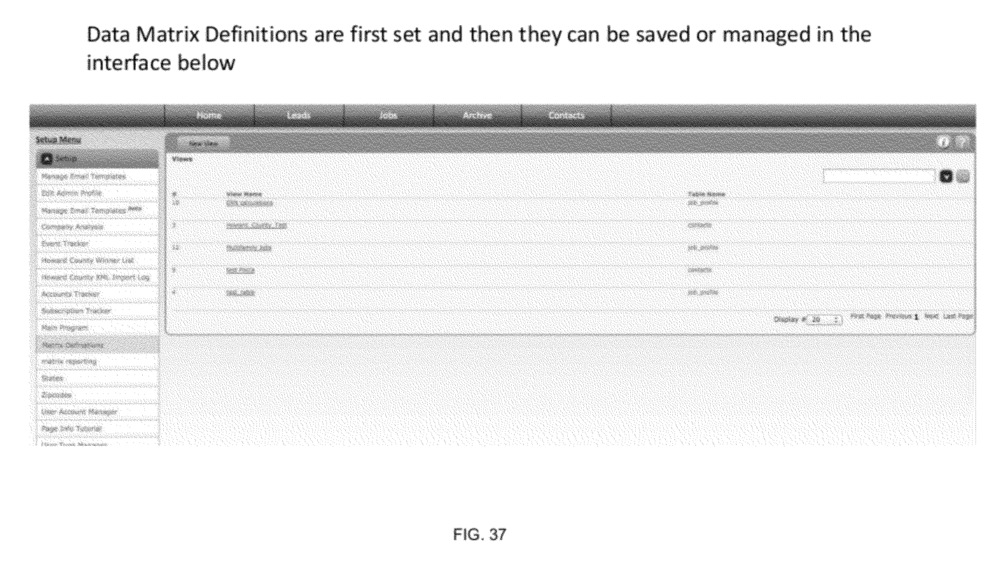

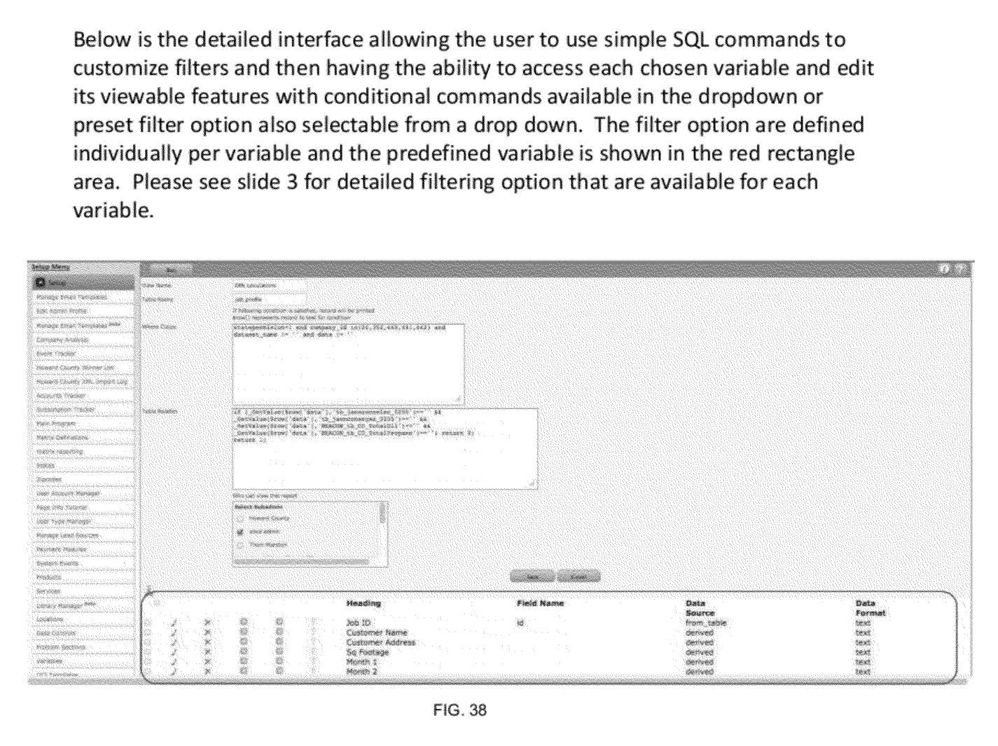

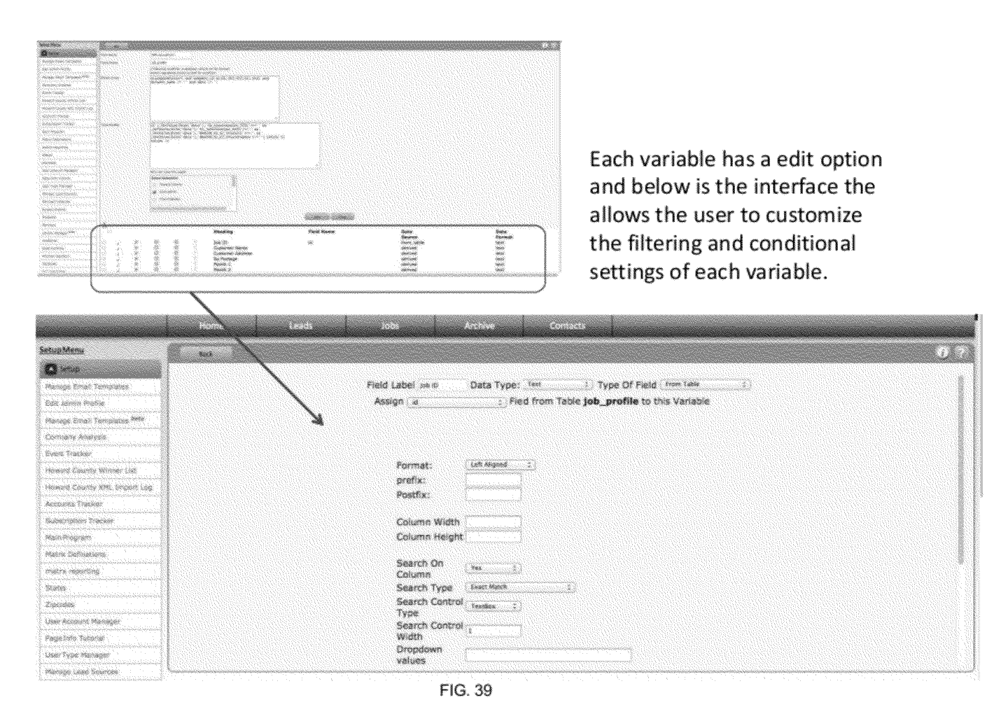

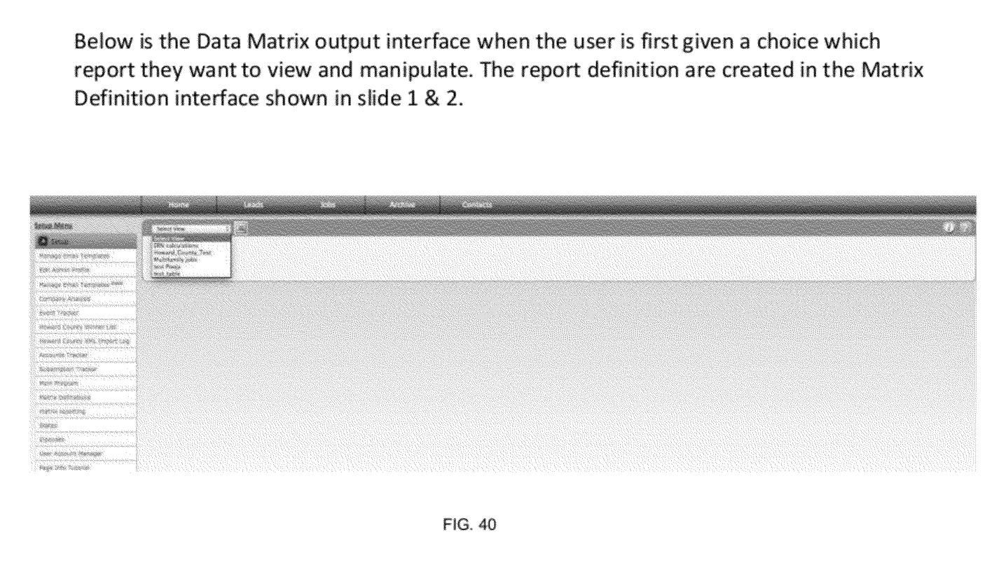

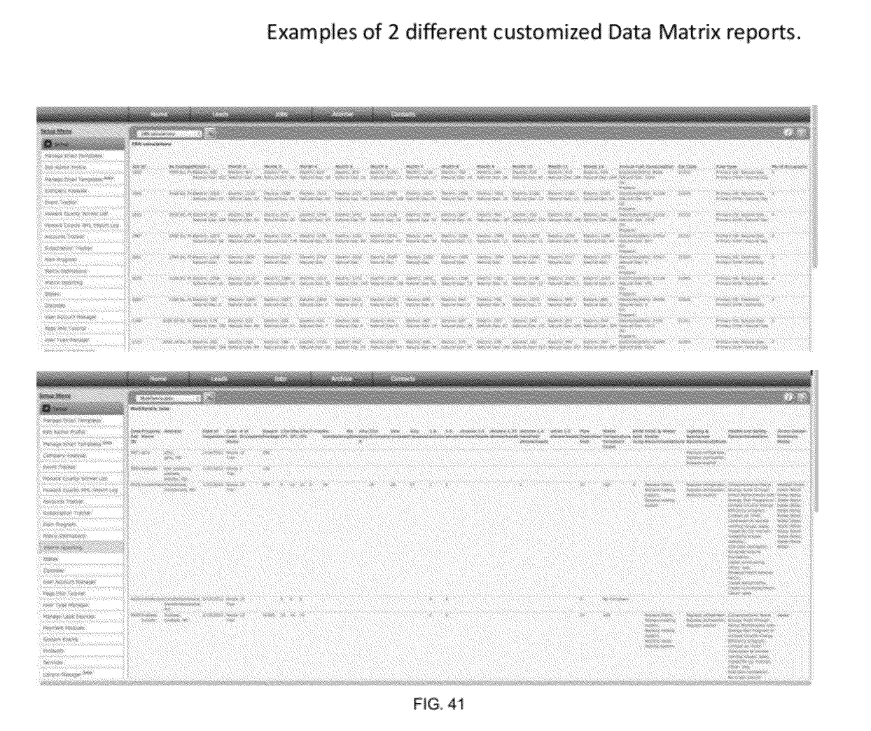

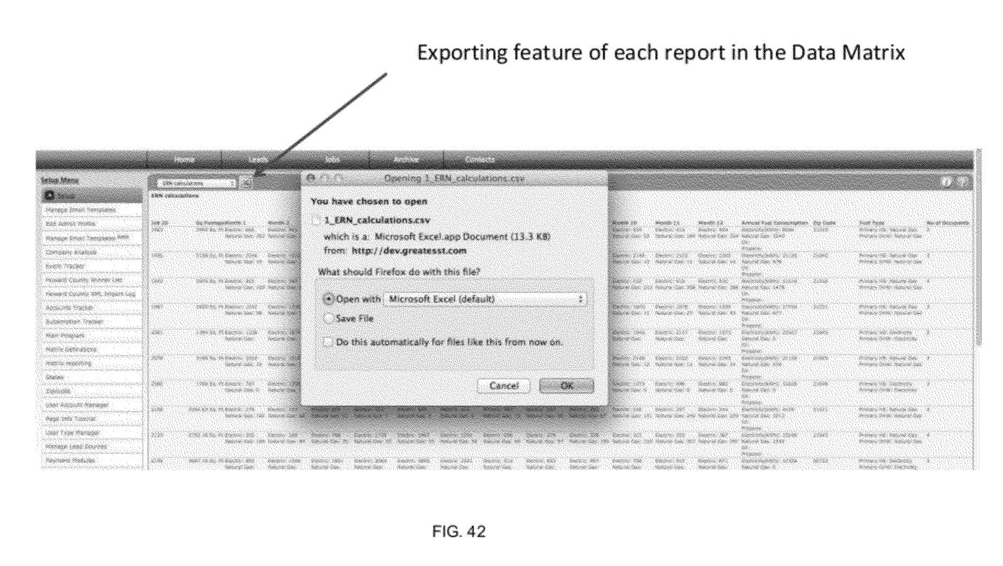

VI. Dynamic Data Matrix with GUI to an MySQL Database Through an Linux Environment (FIGS. 37-42)

With all the data that the gREATESST platform collects/holds, there is an immediate need to run reports or export data out of the system to be used with other software like Excel or others. This platform provides a unique interface in the master admin account that gives a user direct access to the systems MySQL database and run intricate reports or data exports with many customizable filtering features. Templates of report definitions and structures can also be saved so they can be reused over and over or can be accessed by different user accounts with the appropriate permission settings. These reports only consist of data and various aggregate totals or averages and do not provide a graphical representation of this data. For graphical or more complex designs of this data the Report Creation wizard is used. The Data Matrix interface also allows for sql command coding to add even more flexibility and customization of the output features. Please see the Powerpoint file “Dynamic Data Matrix Interface.pptx” for screenshots of this functionality.

The specification continues as the attached appendix.

We claim:

1. A method comprising:
collecting building energy profile data using an electronic communication device;
a networked server receiving via a communication interface the building energy profile data from the electronic communication device, the networked server comprising:
an interactive library of problems and solutions with training;
an estimate creation wizard with report output integration and accounting integration; and
a modular administration program build out; and
auditing the building energy profile data to identify at least one building improvement to improve the energy performance of the building.

2. The method according to claim 1, wherein the training is customized industry training through the problems and solutions library with custom company protocols with pictures, audio, video or text.

3. The method according to claim 1, wherein the estimation creation wizard is connected to suppliers based deals advertising based on data collection; and provides a customized automation, estimate equations, and data report output creation and definition interface.

4. The method according to claim 1, wherein the modular administration program build out is a program/subprogram/stage structure build out.

5. The method according to claim 1, further comprising at least one selected from the group consisting of a specific data collection interface build out an management wizard, specific report output creation wizard, modular financial/payment structure wizard, permission/filter based user account creation wizard, and automatic tiered report outputs based on permissions.

6. The method of claim 1, further comprising an energy audit lead valuation system.

7. The method of claim 6, wherein the energy audit lead valuation system comprises at least one selected from the group consisting of taking third party data sets that have close relation to the energy efficiency/retrofit or real estate data requirements and evaluating its value for potential expansion on this data and assigning lead valuation through the creation of partial or full building improvement data sets for industry specific data collectors based on industry improvement standards.

8. The method according to claim 1, further comprising real time quality assurance dispatching.

9. The method according to claim 1, wherein the electronic communication device is one selected from the group consisting of a net book and an iPad with an external case comprising an infrared camera.

10. The method according to claim 9, wherein the infrared camera is a digital camera comprising a high zoom and flash.

11. The method according to claim 9, wherein the net book further comprises at least one selected from the group consisting of video conference capability and laser measurement tool for a three dimensional (3D) building modeling application.

12. The method according to claim 1, further comprising a dynamic data matrix with GUI to an MySQL database developed in a linux environment.

13. The method according to claim 1, further comprising installing the improvement to the building.

14. The method according to claim 13, further comprising testing out the performance of the improvement.

15. The method according to claim 1, further comprising generating a building improvement plan using the evaluated building energy profile data.

16. The method according to claim 1, further comprising generating a price quotation for the at least one improvement.

17. The method according to claim 1, further comprising scheduling a contractor to install the at least one improvement to the building.

18. The method according to claim 1, wherein the at least one improvement is made on the building by a home improvement contractor.

19. The method according to claim 1, further comprising generating a building energy performance improvement plan using the audit.

20. The method according to claim 1, wherein the audit is generated upon receipt of a customer order.

21. The method according to claim 1, wherein the audit is automatically generated upon acquisition of the building energy profile data.

22. The method according to claim 1, wherein the audit is at least partially generated by the electronic communication device.

23. The method according to claim 1, wherein the audit is generated by the networked server.

24. The method according to claim 19, wherein the building energy performance improvement plan is at least partially generated by the electronic communication device.

25. The method according to claim 19, wherein the building energy performance improvement plan is generated by the server.

26. The method according to claim 1, wherein the at least one building improvement is scheduled from a network of approved building improvement contractors for a particular geographic area.

27. The method according to claim 16, wherein the approved building improvement contractor is selected by the server.

28. The method according to claim 1, wherein the building energy profile data comprises at least one selected from the group consisting of at least one physical measurement of the building, at least one measurement of heat transfer rate of energy moving into or out of the building, at least one digital photograph of the building, at least one record of any damage to the home, and a listing of at least one repair or improvement to the building.

29. The method according to claim 1, wherein the electronic communication device is one selected from the group consisting of a cell phone, personal computer, laptop computer, personal communication device, and portable computer devices.

30. The method according to claim 1, wherein the building energy profile data comprises at least one selected from the group consisting of:
1) house type;
2) number of occupants;
3) year house was built;
4) approx. size of house;
5) primary heating system fuel type;
6) number of heating systems;
7) air conditioning (yes/no);
8) primary domestic hot water fuel type;
9) number of water heaters;
10) electric Service Provider; and
11) fuel Service Provider.
